(19) United States
(12) Patent Application Publication
(10) Pub. No.: US 2022/0236782 A1
(43) Pub. Date: Jul. 28, 2022

(54) SYSTEM AND METHOD FOR INTELLIGENT MULTI-APPLICATION AND POWER MANAGEMENT FOR MULTIMEDIA COLLABORATION APPLICATIONS

(71) Applicant: Dell Products, LP, Round Rock, TX (US)

(72) Inventors: Vivek Viswanathan Iyer, Austin, TX (US); Todd E. Swierk, Austin, TX (US)

(73) Assignee: Dell Products, LP, Round Rock, TX (US)

(21) Appl. No.: 17/160,629

(22) Filed: Jan. 28, 2021

(51) Int. Cl. G06F 1/3212; G06F 9/30; G06F 1/3234; G06N 3/08; G06N 3/04; H04N 7/15; G06T 1/20

(52) U.S. Cl. CPC G06F 1/3212; G06F 9/30083; G06F 1/3259; G06F 3/04883; G06N 3/04; H04N 7/15; G06T 1/20; G06N 3/084

(57) ABSTRACT

A method and system for intelligent collaboration multi-application and power management for an information handling system may comprise joining a videoconference session with multiple participants via a multimedia multi-user collaboration application (MMCA), detecting power connections or battery levels and detecting a current processor consumption by the multimedia multi-user collaboration application and a current MMCA processor settings, and to output from a trained neural network an optimized processor utilization instruction, an optimized A/V processing instruction adjustment, and an optimized media capture instruction adjustment predicted to decrease the power consumed by one or more processors executing code instructions of the MMCA during the videoconference session to fall below the preset power consumption threshold value when applicable. The system and method determining, via a trained neural network, software execution prioritization of other software applications concurrently operating with the MMCA and allocating processing resources or display user interfaces according to priority during a videoconference.

### FIELD OF THE DISCLOSURE

The present disclosure generally relates to multimedia, multi-user collaboration applications, such as videoconferencing applications. More specifically, the present disclosure relates to intelligently managing media capturing, processing, and display pursuant to execution of such applications, based on performance metrics for an information handling system, power settings for the information handling system, and concurrently executing applications.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling may vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. The information handling system may include telecommunication, network communication, and video communication capabilities.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating various drivers and processors in communication with a plurality of peripheral devices of an information handling system according to an embodiment of the present disclosure;

FIG. 3 is a block diagram illustrating a multimedia framework pipeline and infrastructure platform of an information handling system according to an embodiment of the present disclosure;

FIG. 4 is a block diagram illustrating audio/visual (A/V) processing instruction manager for optimizing information handling system operation of a multimedia, multi-user collaboration application (MMCA) according to an embodiment of the present disclosure;

FIG. 5 is a block diagram illustrating a first embodiment of an intelligent collaboration multi-application and power management system for optimizing information handling system operation of an MMCA according to an embodiment of the present disclosure;

FIG. 6 is a block diagram illustrating a second embodiment of an intelligent collaboration multi-application and power management system for optimizing information handling system operation of an MMCA according to an embodiment of the present disclosure;

FIG. 7 is a flow diagram illustrating a method of training a neural network to model a relationship between performance of software applications, including the MMCA, and power consumed during their executions according to an embodiment of the present disclosure;

FIG. 8 is a flow diagram illustrating a method of a trained neural network determining optimized instructions for optimization of power and processor resource consumption by various software applications according to an embodiment of the present disclosure; and

FIG. 9 is a flow diagram illustrating a method of applying optimized A/V processing instruction adjustments and optimized MMCA processor utilization instructions within a videoconference user videoconference session according to an embodiment of the present disclosure.

The use of the same reference symbols in different drawings may indicate similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

As working remotely has gained in popularity, so too has the prevalence of multi-employee or multi-business video conferences. Many participants of video conferences may thus be running various work-related applications concurrently with multimedia multi-user collaboration applications (MMCAs) hosting such video conferences. MMCAs may require a relatively large portion of available power and computing or processing resources, due to the complexity of the methods used to capture, process, and transmit a video of the user, and to display videos of other participants in a single video conference user videoconference session. This may consequently limit the power and processing resources available for allocation to all other concurrently running software applications. Such power and processing limitations may negatively impact performance of such concurrently running software applications. The amount of power and processor resources consumed by such MMCAs during execution of a videoconference user videoconference session may be adjusted by altering the methods for capture and processing of such media samples. Most existing MMCAs perform the highest quality video processing methods on videos of each participant, regardless of the power and processing resources consumed and the impact this consumption has on all other concurrently running applications. A method is needed to balance power and processor resource consumption among a plurality of concurrently running applications that includes the MMCA, based on a detected or determined priority of one or more such concurrently running applications, or on a priority to conserve battery power.

The intelligent collaboration multi-application and power management system in embodiments of the present disclosure addresses these issues by training a machine-learning neural network to optimize application prioritization, as well as resource (e.g., power or processor availability) consumption, based on a context inferred by several input variables. For example, the neural network may be trained to adjust the maximum amount of power the processor may draw, adjust the method in which a media sample is captured to decrease the processing resources (and consequently amount of power drawn by the processor) required to process the captured media sample, or may adjust the processing methods (e.g., Audio/Visual (A/V) processing instructions) applied to the media sample during such post-capture processing. These adjustments may be made in various embodiments in order to cap the power consumed by one or more processors executing code instructions of an MMCA, in order to make more power and processing resources available for consumption by other software applications, or to conserve battery power of the information handling system executing the MMCA. The neural network in embodiments described herein may make such determinations based on various gathered inputs, including current power availability metrics (e.g., operating on battery power or D/C power, battery state of charge, rate at which battery is currently depleting, etc.) for the information handling system executing the MMCA, current media capture instructions, and current A/V processing instructions.

As another example of training a machine learning neural network, a neural network may be trained to adjust a priority in which a plurality of software applications including the MMCA are executed at one or more processors in order to meet a preset performance benchmark for one or more such concurrently executing applications. These preset performance benchmarks in various embodiments may be specific to the type of applications having a higher priority, such as the MMCA itself, or a note-taking application a user routinely runs concurrently with the MMCA. For example, preset performance benchmarks for the MMCA may include a maximum allowable latency between capture of a media sample at one participating information handling system and playback of that media sample at another information handling system. Another example preset performance benchmark for the MMCA may include a maximum allowable number of dropped packets or jitter associated with transmission and playback of media samples between such participating information handling system. Preset performance benchmarks may be applied for other applications, such as a note-taking application receiving input from a peripherally connected stylus device in embodiments and may include, for example, a lag measurement for the signal received from the peripheral stylus device sensor at the information handling system and an action (e.g., a writing mark) occurring in the note-taking application user interface. The neural network in such example embodiments may be trained to optimize performance of the MMCA, and the note-taking application (or other prioritized software applications running concurrently with the MMCA) in order to meet these preset performance benchmarks by prioritizing their execution at the processor, or by adjusting the methods by which the MMCA captures and processes media samples during such execution.

In yet another example of training a machine learning neural network, a neural network may be trained to prioritize execution of the MMCA over execution of a plurality of other software applications at one or more processors, or adjust resource (e.g., power or processor availability) consumption by these other software applications in order to improve performance of the MMCA during execution of a videoconference user videoconference session. This may be achieved, for example, by training the neural network to output an optimized processing priority list that prioritizes the MMCA over other software applications, and an optimized processor utilization instructions predicted to cap power consumed by the processor during execution of the other software applications. In such a way, the neural network may be trained to conserve processing power and resources for execution of the MMCA. The neural network in embodiments may also be trained to output optimized methods of media sample capture and processing predicted to optimize performance of the MMCA.

The trained neural network (or neural networks) of the intelligent collaboration multi-application and power management system may be executed on (or at a remote location for) a user's information handling system, where each user videoconference session may run concurrently with different types of other software applications having differing priority levels with respect to the MMCA, and under varying power availability circumstances (e.g., operating on battery power or on AC power). In embodiments described herein, the term “media” may refer to images or video samples (e.g., compilation of several images over time) captured by a camera, audio samples captured by a microphone, or a combination of audio and video samples to form a media sample providing both audio and video.

The intelligent collaboration multi-application and power management system, or portions thereof, may operate remotely from the information handling system for which the neural network is trained in some embodiments. For example, the intelligent collaboration multi-application and power management system may operate as part of an information handling system performance optimizer application hosted, for example, by the manufacturer of the information handling system, or managed by the information handling system user's employer or Information Technology (IT) manager. Such an information handling system performance optimizer application may operate in example embodiments in various contexts to monitor certain performance metrics at the information handling system, perform firmware and software updates, confirm security credentials and compliance, and manage user access across a plurality of information handling systems (e.g., as owned by an employer or enterprise corporation). In such embodiments, the intelligent collaboration multi-application and power management system may receive such performance metrics and metrics describing previous MMCA user videoconference sessions for an information handling system via any type of network, including out-of-band communications, and communications with one or more software applications, application programming interfaces (APIs), or directly with one or more controllers or firmware in kernel mode. In some embodiments described herein, the neural network trained for the transmitting information handling system may do so remotely from the transmitting information handling system engaging in such user videoconference sessions. In other embodiments described herein, the neural network may be transmitted to an agent of the intelligent collaboration multi-application and power management system operating at the information handling system through which a user for the MICA may join a user videoconference session in progress.

The intelligent collaboration multi-application and power management system in embodiments may transmit other optimized processor utilization instructions for capping the power drawn by one or more processors, or an optimized application execution prioritization instruction prioritizing execution of one or more software applications to a diagnostic analysis application of an information handling system participating in a current videoconference user videoconference session. The diagnostic analysis application may then enforce these optimized instructions during execution of various software applications, including the MMCA, to conserve power consumed at those processors for execution of the higher priority applications.

Following training of the neural network or neural networks in embodiments herein, the trained neural network may receive updated values for the inputs upon which it was trained in order to determine optimized instructions for balancing power consumption and performance of various software applications, including the MMCA during a videoconference user videoconference session. The intelligent collaboration multi-application and power management system in embodiments may transmit outputs from the trained neural network, such as optimized media capture instruction adjustments and optimized A/V processing instruction adjustments for adjusting the methods of capture and processing of media samples to a multimedia framework pipeline and infrastructure platform of an information handling system participating in a current videoconference user videoconference session. In some embodiments, the intelligent collaboration multi-application and power management system may also transmit an optimized processor utilization instruction output by the trained neural network to the multimedia framework pipeline and infrastructure platform for offloading one or more of the A/V processing instructions to a specific processor or limiting power to a processor to throttle processors and consequent power consumption.

The multimedia framework pipeline and infrastructure platform in embodiments may process, in accordance with the optimized A/V processing instruction adjustments and optimized processor utilization instructions, audio samples or video samples. These media samples may have also been captured at the information handling system according to the optimized media capture instruction adjustments. Such processing is done in order to create processed, encoded media samples that combine both video and audio samples into a single file. Media samples may be referred to herein as “processed” when the video sample or audio sample upon which the media sample is created has undergone at least one A/V processing instruction, which may include an encoding process, or other audio/video processing methods (e.g., zooming, virtual background application, cropping, user framing, resolution adjustment, normalization, boundary detection, background noise reduction, etc.). Following the processing of media samples, the multimedia framework pipeline and infrastructure platform may transmit the processed, encoded media sample that includes video of the information handling system user to the MMCA for the information handling system. The processed, encoded media sample may then be transmitted to other information handling systems (e.g., receiving information handling systems) in use by other participants within the current user videoconference session for the MMCA, via a MMCA host server. These receiving information handling systems may then reprocess and decode the received media sample, for playback at the displays for these receiving information handling systems. In such a way, the intelligent collaboration multi-application and power management system may optimize power and processor resource consumption by various software applications including the MMCA, during a videoconference session, based on availability of such power or resources and priority of software applications in an embodiment.

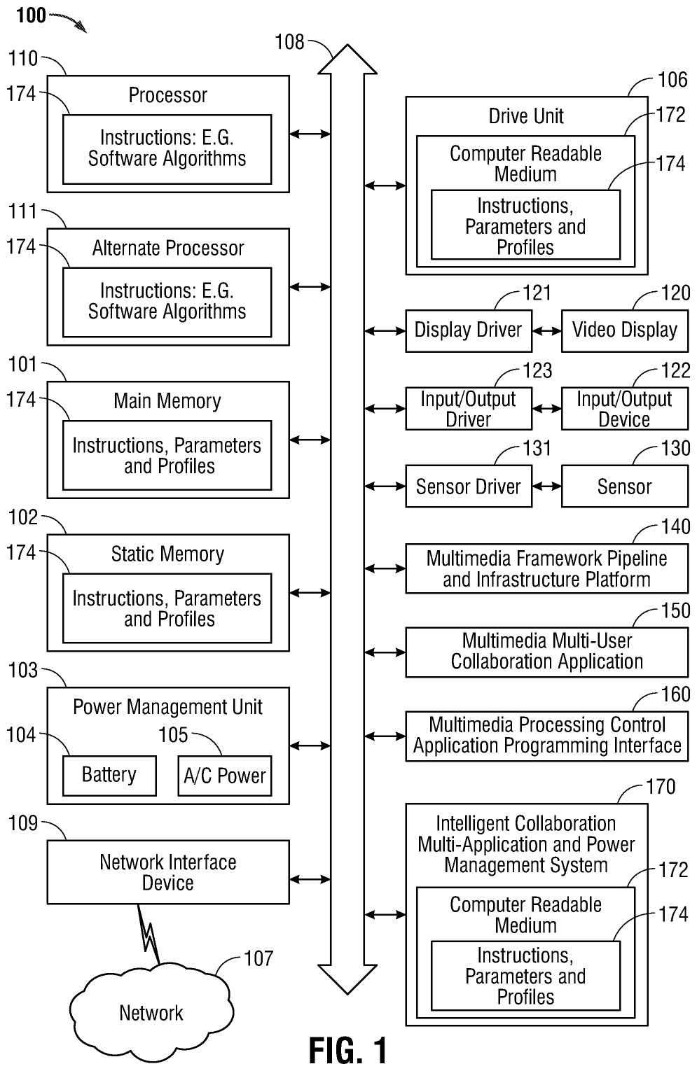

Turning now to the figures, FIG. 1 illustrates an information handling system 100 similar to information handling systems according to several aspects of the present disclosure. As described herein, the intelligent collaboration multi-application and power management system 170 in an embodiment may operate to optimize power and processor resource consumption by various software applications including a multimedia multi-user collaboration application (MMCA) 150 hosting a videoconference session, based on availability of such power or resources and priority of software applications executing at the information handling system 100. The information handling system 100 in an embodiment described with reference to FIG. 1 may represent an information handling system capturing, processing, and transmitting a media sample capturing an image of a participant in a videoconference user videoconference session. In another embodiment, the information handling system 100 may operate remotely from the information handling systems executing code instructions of the MMCA 150 to participate within a user videoconference session. For example, the intelligent collaboration multi-application and power management system 170 may operate on a server, blade, rack, or cloud-based network maintained and controlled by the manufacturer of several information handling systems, or managed by an employer or enterprise owner of several information handling systems. In such an embodiment, the information handling system 100 may operate within one of these servers, blades, racks, or across various nodes of a cloud-based network. For example, information handling system 100 may be used to monitor certain performance metrics at each of the plurality of such information handling systems, perform firmware and software updates, confirm security credentials and compliance, manage user access across the plurality of information handling systems (e.g., as owned by an employer or enterprise corporation, or conduct other maintenance for an enterprise. In an embodiment, each of the plurality of information handling systems participating within a user videoconference session of the MMCA 150 may incorporate an agent or API for the intelligent collaboration multi-application and power management system 170.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 may be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a communications device, an access point (AP), a base station transceiver, a wireless telephone, a control system, a camera, a scanner, a printer, a pager, a personal trusted device, a web appliance, or any other suitable machine capable of executing a set of instructions (sequential or otherwise) that specify actions to be taken by that machine, and may vary in size, shape, performance, price, and functionality.

The information handling system may include memory (volatile (e.g., random-access memory, etc.), nonvolatile (read-only memory, flash memory etc.) or any combination thereof), one or more processing resources, such as a central processing unit (CPU), a graphics processing unit (GPU), a vision processing unit (VPU), a Gaussian neural accelerator (GNA), hardware or software control logic, or any combination thereof. Additional components of the information handling system 100 may include one or more storage devices, one or more communications ports for communicating with external devices, as well as various input and output (I/O) devices 122, such as a keyboard, a mouse, one or more microphones, one or more speakers, a touchpad, or any combination thereof. The information handling system 100 may also include various sensors 130 (e.g., Hall effect positional sensors, hinge rotation sensors, geographic locations sensors such as GPS systems, light sensors, time of flight sensors, infrared sensors, etc.). A power management unit 103 supplying power to the information handling system 100, via a battery 104 or an alternating current (A/C) power adapter 105. PMU 103 may gather power metrics monitoring power states including A/C power configuring residual state of charge of the battery current draw of the information handling system 100 or components, or apply power limitation measures to conserve power may also be included within information handling system 100. One or more buses (e.g., 108) operable to transmit communications between the various hardware components. The information handling system 100 may further include a video display 120. The video display 120 in an embodiment may function as a liquid crystal display (LCD), an organic light emitting diode (OLED), a flat panel display, or a solid-state display. Portions of an information handling system 100 may themselves be considered information handling systems 100.

In an example embodiment, the information handling system 100 may include a laptop or desktop system that executes the MMCA 150 that may operate as a videoconferencing application. The MMCA 150 may include any computer code that is executed by a processor 110, or other processors of the information handling system 100 in order to decrease the load on the processor during execution of various A/V processing instruction modules for processing a captured media sample, for capture and encoding of media samples for transmission, pursuant to execution of the MMCA 150 as a video conferencing application. The multimedia framework pipeline and infrastructure platform 140 in an embodiment may execute code instructions to direct execution of specific processing and encoding of media samples for transmission.

The MMCA 150 in an embodiment may transmit to the multimedia framework pipeline and infrastructure platform 140 default settings for such processing, and encoding (e.g., via bus 108). Such default settings may not be optimized, and may result in unnecessarily high consumption of resources at the processor 102 of the information handling system 100. The intelligent collaboration multi-application and power management system 170 in an embodiment may operate to determine optimized media capture instruction adjustments, optimized A/V processing instructions, optimized processor utilization instruction, or an optimized application execution prioritization instruction at the information handling system (e.g., 100) for execution of various aspects of the MMCA 150 or other software applications executing concurrently with the MMCA 150 during a videoconference user videoconference session. The optimized processor utilization instruction in an example embodiment may include an optimized offload instruction identifying a type of alternate processor 111 (e.g., GPU, VPU, GNA) used to execute various aspects of the multimedia framework pipeline and infrastructure platform 140. In another example embodiment, the optimized processor utilization instruction may cap the power drawn from the power management unit 103 by the processor 110 or the alternate processor 111 during execution of the MICA or any other concurrently executing software application.

The intelligent collaboration multi-application and power management system 170 in an embodiment may include code instructions 174 for training a neural network, or for executing a neural network. In an embodiment in which the intelligent collaboration multi-application and power management system 170 operates to train a neural network, the information handling system 100 may represent the transmitting information handling system, or an information handling system located remotely from the transmitting information handling systems. The intelligent collaboration multi-application and power management system 170 in each of these embodiments may gather various input values from a plurality of information handling systems executing the MMCA (e.g., 150) in order to optimize power and processor resource consumption by various software applications, including the MMCA, during a videoconference session, based on availability of such power or resources and user priority of software applications.

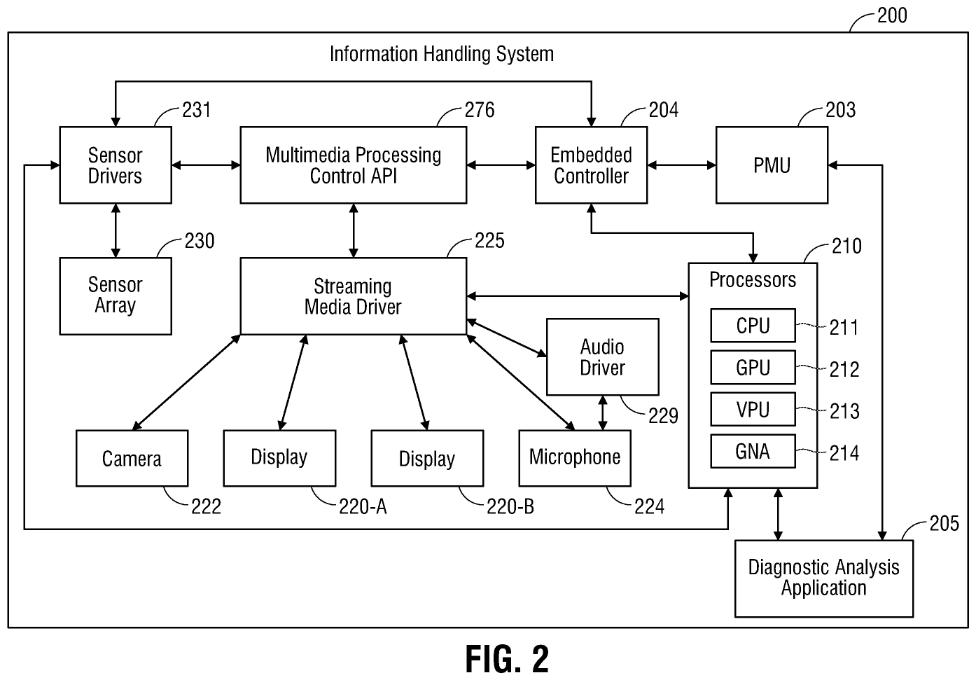

The multimedia processing control API 160 in an embodiment may operate to facilitate communication between various applications, controllers, and drivers of the information handling system 100 in an embodiment. For example, in an embodiment in which the neural network is trained remotely from the information handling system 100 (e.g., the information handling system represents a transmitting information handling system), the multimedia processing control API 160 may operate to gather input values for the neural network from the input/output driver 123, sensor driver 131, multimedia framework pipeline and infrastructure platform 140, processor 110, main memory 101, power management unit 103, network interface device 109, or MMCA 150 (e.g., via bus 108). For example, the multimedia processing control API 160 in an embodiment may gather power metrics including a docking status of the information handling system 100 (e.g., indicating whether the information handling system is docked and connected to AC power), the residual state of charge for the battery 104, current consumption rate of the residual state of charge of battery 104, or a maximum processor power setting capping the power drawn by the processor 110 or alternate processor 111 from the power management unit 103. In another example embodiment, these power metrics may be gathered by an embedded controller, as described in greater detail with respect to FIG. 2.

The multimedia processing control API 160 or embedded controller in an embodiment may transmit such gathered inputs to the remotely located system for training the neural network via network interface device 109 and network 107 in embodiments in which the neural network is trained remotely from the information handling system 100. The trained neural network may then be executed in the same remote location, or may be transmitted to the information handling system 100 via network 107 for storage in main memory 101, static memory 102, or drive unit 106 (e.g., as instructions 174). In an embodiment in which the neural network is trained at the information handling system 100, the multimedia processing control API 160 may transmit the gathered inputs to the intelligent collaboration multi-application and power management system 170 operating at the information handling system 100 (e.g., as instructions 174).

Upon execution of the trained neural network (e.g., as instructions 174) in an embodiment, and during execution of a user videoconference session via the MMCA 150, the multimedia processing control API 160 may gather current input values for the trained neural network in a similar manner as the training session. The multimedia processing control API 160 in such an embodiment may transmit such gathered inputs to the intelligent collaboration multi-application and power management system (or agent) 170 executing the trained neural network (e.g., instructions 174). The trained neural network may then output optimized A/V processing instruction adjustments, optimized processor utilization instructions, optimized media capture instruction adjustments, or optimized application execution prioritization instructions. The optimized A/V processing instruction adjustments and one or more optimized processor utilization instructions may be transmitted to the multimedia framework pipeline and infrastructure platform 140 in an embodiment. The optimized media capture instruction adjustments may be transmitted to an input/output driver 123 (e.g., streaming media driver described in greater detail with respect to FIG. 2) for input/out device 122 (e.g., camera or microphone described in greater detail with respect to FIG. 2). The optimized application execution prioritization instructions and one or more optimized processor utilization instructions capping the power drawn by processors may be transmitted to the multimedia processing control API 160 in an embodiment, for further transmission to a diagnostic analysis application, as described in greater detail with respect to FIG. 2.

In an embodiment, a camera operating as the input/output device 122 may capture video of a user of the information handling system, and transmit the captured video sample to the multimedia framework pipeline and infrastructure platform via a streaming media driver or video driver operating as input/output driver 123. In another example of such an embodiment, a microphone operating as the input/output device 122 may capture audio of a user of the information handling system, and transmit the captured audio sample to the multimedia framework pipeline and infrastructure platform via a streaming media driver or audio driver operating as input/output driver 123. The multimedia framework pipeline and infrastructure platform 140 may apply one or more A/V processing instruction modules to the captured video or audio samples. The multimedia framework pipeline and infrastructure platform 140 in such an embodiment may engage the processor 110 or alternate processor 111 (e.g., CPU, GPU, VPU, GNA) identified within the optimized processor utilization instructions to execute such A/V processing instruction modules on the captured video or audio samples to generate a processed, encoded media sample combining the video and audio samples. By capturing and processing the audio and video samples using these optimized instructions, the intelligent collaboration multi-application and power management system 170 may direct various components of the transmitting information handling system (e.g., 100) to use less CPU (e.g., 110) resources and power during such processing, and to decrease the streaming data size for the resulting media sample which may further reduce processing load and power consumed. The MMCA 150 may then direct transmission of the processed, encoded media sample to other information handling systems operated by other participants of the user videoconference session for the MMCA 150, via network interface device 109 and network 107.

In a networked deployment, the information handling system 100 may operate in the capacity of a server or as a client computer in a server-client network environment, or as a peer computer system in a peer-to-peer (or distributed) network environment. In a particular embodiment, the information handling system 100 may be implemented using electronic devices that provide voice, video or data communication. For example, an information handling system 100 may be any mobile or other computing device capable of executing a set of instructions (sequential or otherwise) that specify actions to be taken by that machine. Further, while a single information handling system 100 is illustrated, the term “system” shall also be taken to include any collection of systems or sub-systems that individually or jointly execute a set, or multiple sets, of instructions to perform one or more computer functions.

Information handling system 100 may include devices or modules that embody one or more of the devices or execute instructions for the one or more systems and modules described herein, and operates to perform one or more of the methods described herein. The information handling system 100 may execute code instructions 174 that may operate on servers or systems, remote data centers, or on-box in individual client information handling systems according to various embodiments herein. In some embodiments, it is understood any or all portions of code instructions 174 may operate on a plurality of information handling systems 100.

The information handling system 100 may include a processor 110 such as a CPU, GPU, VPU, GNA, control logic or some combination of the same. Any of the processing resources may operate to execute code that is either firmware or software code. Specifically, the processor 110 may operate to execute code instructions of firmware for the input/output driver 123 in an embodiment. Moreover, the information handling system 100 may include memory such as main memory 101, static memory 102, or other memory of computer readable medium 172 storing instructions 174 of the intelligent collaboration multi-application and power management system 170 for optimizing execution of a user videoconference session of the MMCA 150, and drive unit 106 (volatile (e.g., random-access memory, etc.), nonvolatile memory (read-only memory, flash memory etc.) or any combination thereof. A processor 110 may further provide the information handling system with a system clock for which a time of day clock may be tracked along with any location detector such as global positioning system or in coordination with a network interface device 109 connecting to one or more networks 107. The information handling system 100 may also include one or more buses 108 operable to transmit communications between the various hardware components such as any combination of various input and output (I/O) devices.

The network interface device 109 may provide wired or wireless connectivity to a network 107, e.g., a wide area network (WAN), a local area network (LAN), wireless local area network (WLAN), a wireless personal area network (WPAN), a wireless wide area network (WWAN), or other network. Connectivity may be via wired or wireless connection. The network interface device 109 may operate in accordance with any wireless data communication standards. To communicate with a wireless local area network, standards including IEEE 802.11 WLAN standards, IEEE 802.15 WPAN standards, WWAN such as 3GPP or 3GPP2, or similar wireless standards may be used. In some aspects of the present disclosure, one network interface device 109 may operate two or more wireless links. Network interface device 109 may also connect to any combination of macro-cellular wireless connections including 2G, 2.5G, 3G, 4G, 5G or the like. Utilization of radiofrequency communication bands according to several example embodiments of the present disclosure may include bands used with the WLAN standards and WWAN carriers, which may operate in both licensed and unlicensed spectrums.

In some embodiments, software, firmware, dedicated hardware implementations such as application specific integrated circuits, programmable logic arrays and other hardware devices may be constructed to implement one or more of some systems and methods described herein. For example, some embodiments may include operation of embedded controllers for various applications or input/output devices 122.

Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations may include distributed processing, component/object distributed processing, and parallel processing. Alternatively, virtual computer system processing may be constructed to implement one or more of the methods or functionalities as described herein.

The present disclosure contemplates a computer-readable medium that includes instructions, parameters, and profiles 174 or receives and executes instructions, parameters, and profiles 174 responsive to a propagated signal, so that a device connected to a network 107 may communicate voice, video or data over the network 107. Further, the instructions 174 may be transmitted or received over the network 107 via the network interface device 109.

The information handling system 100 may include a set of instructions 174 that may be executed to cause the computer system to perform any one or more of the methods or computer-based functions disclosed herein. As an example, instructions 174 may execute an intelligent collaboration multi-application and power management system 170, software agents, or other aspects or components. Various software modules comprising application instructions 174 may be coordinated by an operating system (OS), and/or via an application programming interface (API). An example operating system may include Windows®, Android®, and other OS types. Example APIs may include Win 32, Core Java API, or Android APIs.

The disk drive unit 106 and the intelligent collaboration multi-application and power management system 170 may include a computer-readable medium 172 in which one or more sets of instructions 174 such as software may be embedded. Similarly, main memory 101 and static memory 102 may also contain a computer-readable medium for storage of one or more sets of instructions, parameters, or profiles 174. The disk drive unit 106 and static memory 102 may also contain space for data storage. Further, the instructions 174 may embody one or more of the methods or logic as described herein. For example, instructions relating to the intelligent collaboration multi-application and power management system 170, code instructions of a trained neural network, software algorithms, processes, and/or methods may be stored here. In a particular embodiment, the instructions, parameters, and profiles 174 may reside completely, or at least partially, within the main memory 101, the static memory 102, and/or within the disk drive 106 during execution by the processor 110 of information handling system 100. As explained, some of or all the intelligent collaboration multi-application and power management system 170 may be executed locally or remotely. The main memory 101 and the processor 110 also may include computer-readable media.

Main memory 101 may contain computer-readable medium, such as RAM in an example embodiment. An example of main memory 101 includes random access memory (RAM) such as static RAM (SRAM), dynamic RAM (DRAM), non-volatile RAM (NV-RAM), or the like, read only memory (ROM), another type of memory, or a combination thereof. Static memory 102 may contain computer-readable medium (not shown), such as NOR or NAND flash memory in some example embodiments. The intelligent collaboration multi-application and power management system 170 may be stored in static memory 102, or the drive unit 106 on a computer-readable medium 172 such as a flash memory or magnetic disk in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to store information received via carrier wave signals such as a signal communicated over a transmission medium. Furthermore, a computer readable medium may store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may further include a power management unit (PMU) 103 (a.k.a. a power supply unit (PSU)). The PMU 103 may manage the power provided to the components of the information handling system 100 such as the processor 110 (e.g., CPU) or alternate processor 111 (GPU, VPU, GNA, etc.), a cooling system such as a bank of fans, one or more drive units 106, the video/graphic display device 120, and other components that may require power when a power button has been actuated by a user. In an embodiment, the PMU 103 may be electrically coupled to the bus 108 to provide this power. The PMU 103 may regulate power from a power source such as a battery 104 or A/C power adapter 105. In an embodiment, the battery 104 may be charged via the A/C power adapter 105 and provide power the to the components of the information handling system 100 when A/C power from the A/C power adapter 105 is removed. In some embodiments, the power adapter 105 may execute the optimized processor utilization instructions output from the trained neural network to cap the amount of power that may be drawn by the processor 110 or alternate processor 111.

The information handling system 100 may also include the intelligent collaboration multi-application and power management system 170 that may be operably connected to the bus 108. The intelligent collaboration multi-application and power management system 170 may access computer readable medium 172 space for data storage. The intelligent collaboration multi-application and power management system 170 may, according to the present description, perform tasks related to optimizing power and processor resource consumption by various software applications including the MMCA. During a videoconference session, such optimizations may be based on availability of such power or resources and priority of software applications. The intelligent collaboration multi-application and power management system 170 in an embodiment may execute code instructions of a trained neural network to determine an output for optimized media capture instruction adjustments, optimized A/V processing instruction adjustments, optimized processor utilization instructions, or optimized application execution prioritization instructions for achieving this goal. In such an embodiment, the intelligent collaboration multi-application and power management system 170 may have a convolutional neural network that is trained by receiving, as training input, processing or system capabilities, various power metrics, performance metrics for a plurality of software applications including the MMCA, a positional configuration for the information handling system, indicators of communication with peripheral devices (e.g., stylus), current or default GUI display layouts, a list of concurrently operating applications, meeting metrics gathered by the MMCA, current or default media capture instructions, current or default A/V processing instructions, current or default processor utilization instructions, or current or default application execution prioritization instructions.

In an embodiment, the intelligent collaboration multi-application and power management system 170 may be code instructions and operate with the main memory 101, the processor 110, the alternate processor 111, the multimedia processing control API 160, various embedded controllers and the NID 109 via bus 108, and several forms of communication may be used, including ACPI, SMBus, a 24 MHZ BFSK-coded transmission channel, or shared memory. Driver software, firmware, controllers, and the like may communicate with applications on the information handling system 100.

Driver software, firmware, controllers and the like may communicate with applications on the information handling system 100, for example via the input/output driver 123 or the sensor driver 131. Similarly, video display driver software, firmware, controllers and the like may communicate with applications on the information handling system 100, for example, via the display driver 121. In other embodiments, dedicated hardware implementations such as application specific integrated circuits, programmable logic arrays and other hardware devices may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

When referred to as a “system”, a “device,” a “module,” a “controller,” or the like, the embodiments described herein may be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module may include software, including firmware embedded at a device, such as an Intel® Core class processor, ARM® brand processors, Qualcomm® Snapdragon processors, or other processors and chipsets, or other such device, or software capable of operating a relevant environment of the information handling system. The system, device, controller, or module may also include a combination of the foregoing examples of hardware or software. In an embodiment an information handling system 100 may include an integrated circuit or a board-level product having portions thereof that may also be any combination of hardware and software. Devices, modules, resources, controllers, or programs that are in communication with one another need not be in continuous communication with each other, unless expressly specified otherwise. In addition, devices, modules, resources, controllers, or programs that are in communication with one another may communicate directly or indirectly through one or more intermediaries.

FIG. 2 is a block diagram illustrating various drivers and processors in communication with a plurality of peripheral devices, software applications, and one or more processors according to an embodiment of the present disclosure. As described herein, the intelligent collaboration multi-application and power management system may optimize power and processor resource consumption by various software applications including a multimedia multi-user collaboration application (MMCA), during a videoconference session, based on availability of such power or resources and priority of software applications. The intelligent collaboration multi-application and power management system in various embodiments may modify instructions for capturing media samples via a camera 222, or settings for A/V processing instruction modules applied to such captured media samples in post capture processing in order to optimize performance of the MMCA or other prioritized software applications on the information handling system 200, or conserve residual battery power. In another aspect of various embodiments, the intelligent collaboration multi-application and power management system may modify or institute processor utilization instructions to optimize one or more processors' consumption of power during execution of the MMCA or various other software applications, or distribute code instruction execution of one or more MMCA A/V processing instruction modules across a plurality of processors, to optimize power consumption during a videoconference user videoconference session. In still another aspect of an embodiment, the intelligent collaboration multi-application and power management system may modify or institute a prioritization of various software applications, including the MMCA executing such a videoconference user videoconference session to optimize performance of the MMCA or other specifically identified software applications having a relatively higher priority during a videoconference session (e.g., note-taking application receiving input from a peripherally attached stylus).

A neural network of the intelligent collaboration multi-application and power management system in an embodiment may make such optimization determinations for each individual information handling system (e.g., 200) separately. Such a determination may be made based upon a plurality of inputs describing hardware and software capabilities and performance metrics of the information handling system at issue, various power metrics, performance metrics for a plurality of software applications including the MMCA, a positional configuration for the information handling system, indicators of communication with peripheral devices (e.g., stylus), current or default GUI display layouts, a list of concurrently operating applications, meeting metrics gathered by the MMCA, current or default media capture instructions, current or default A/V processing instructions, current or default processor utilization instructions, or current or default application execution prioritization instructions.

These neural network input values may be gathered from a plurality of sensors, peripheral devices, and diagnostic applications. For example, hardware performance metrics describing total processing load at one or more processors 210 may be gathered via an embedded controller 204 in an embodiment. The embedded controller 204 may also gather power metrics describing state of charge for a power management unit 203, which may include a battery and an alternating current (AC) adapter, as well as a rate at which the residual state of charge is being consumed, as described with reference to FIG. 1. Such state of charge information may be gathered by the embedded controller 204 in an embodiment while the information handling system 200 is operating solely on battery power, and when the PMU 203 is receiving power via the AC adapter. The embedded controller 204 in an embodiment may gather such metrics through direct communication with the processor 210 (e.g., CPU, GPU, VPU, GNA, etc.) and with the power management unit (PMU) 203. In some embodiments, such communication may occur in kernel mode.

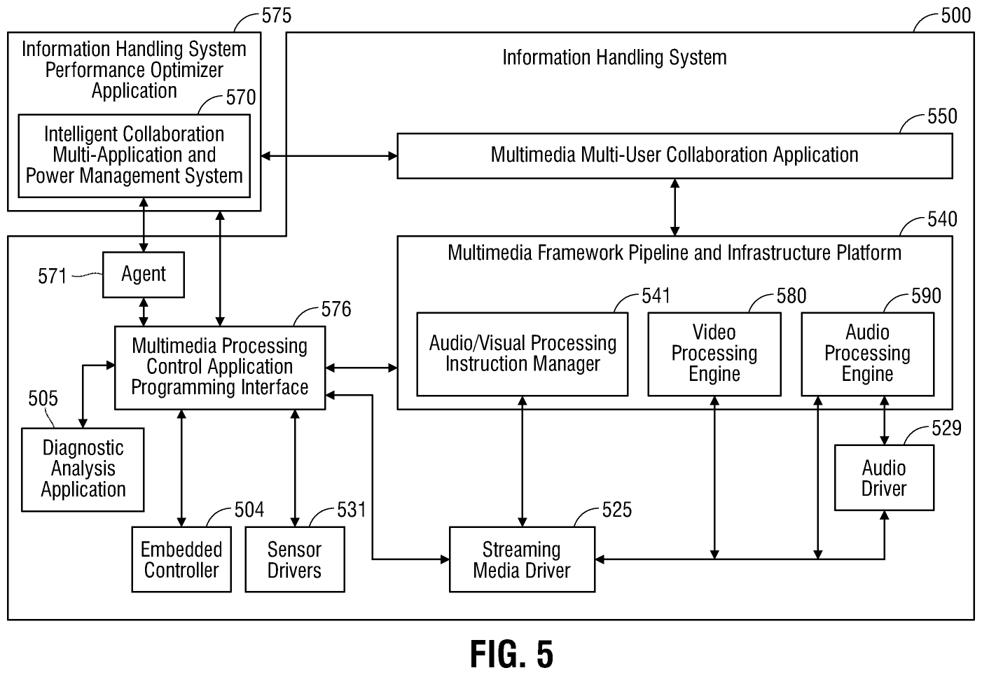

As described in greater detail with reference to FIG. 5, the intelligent collaboration multi-application and power management system may be integrated, in whole or in part, in some embodiments within an information handling system performance optimizer application located remotely from the information handling system 200. In such an embodiment, the information handling system performance optimizer application may operate to manage security credentials, connectivity credentials, performance optimization, software updates, and other various routine computing maintenance tasks for a plurality of information handling systems (e.g., including 200) owned by an enterprise business or produced by a single manufacturer. The Dell® Optimizer® software application is one example of such an information handling system performance optimizer application. The information handling system performance optimizer application in such an embodiment may communicate with the embedded controller 204 to receive high-level hardware performance metrics from each of the plurality of information handling systems (e.g., including 200) it manages during routine out-of-band communications between the information handling system performance optimizer application and all managed information handling systems. Such out-of-band communications with the embedded controller 204 in an embodiment may be used to check security credentials or performance statistics for the information handling systems (e.g., 200), or to push software or firmware updates to the information handling systems, for example. During such routine maintenance, the information handling system performance optimizer application may accumulate, sort, and analyze all performance metrics received from all managed information handling systems (e.g., 200), including processing load across all available processors 210 (e.g., CPU, GPU, VPU, GNA), default settings associating specific processors (e.g., 210) with specific tasks, or state of remaining charge of the battery incorporated within the PMU 203, for example. Out-of-band communications initiated in such a way between the embedded controller 204 and the information handling system performance optimizer application may be via a wireless network such as Wi-Fi or cellular, or via wired connection. Such out-of-band communications operate without need for Operating System intervention or function and may operate behind the scenes to ensure optimized function for managed information handling systems.

As another example of gathering inputs for a neural network of the intelligent collaboration multi-application and power management system, software performance metrics, or application execution prioritization instructions may be generated at a diagnostic analysis application 205, based at least in part on communication between the diagnostic analysis application 205 and the processor 210. Such a diagnostic analysis application 205 may operate to gather metrics describing CPU usage or load, as well as a breakdown of the CPU usage attributable to each of a plurality of applications (e.g., including a MMCA) running via the operating system of the information handling system 200. In some embodiments, the diagnostic analysis application 205 may provide similar metrics for other types of processors for the information handling system, including, for example, a graphics processing unit (GPU), vision processing unit (VPU), or gaussian neural accelerator (GNA). One example of such a diagnostic analysis application 205 in an embodiment may include the Microsoft® Diagnostic Data Viewer® software application. As described in greater detail with respect to FIG. 5, these software performance metrics may be generated at the diagnostic analysis application 205 and transmitted to the neural network of the intelligent collaboration multi-application and power management system via multimedia processing controller API 276.

Another example of such a diagnostic analysis application 205 in an embodiment may include a Dell Precision Optimizer® software application, which may execute application execution prioritization instructions to direct one or more processors 210 to prioritize execution of code instructions received from software applications identified as high priority in application execution prioritization instructions over execution of other concurrently executing software applications. The diagnostic analysis application 205 in an embodiment may also be in communication with the PMU 203 to limit power drawn from one or more processors 210 from the PMU 203 in accordance with an optimized processor utilization instruction output by the trained neural network.

In yet another example of gathering inputs for a neural network of the intelligent collaboration multi-application and power management system, various sensor readings may be taken by the information handling system 200 and communicated to the intelligent collaboration multi-application and power management system. More specifically, the information handling system 200 may include one or more sensors within a sensor array 230. Such sensors may include, for example, a configuration sensor (e.g., a hall effect sensor or hinge rotation sensor, accelerometer, gyroscope, orientation sensor, light sensors, IR cameras, etc.) capable of detecting a current configuration base portion or display portion of a laptop or tablet information handling system (e.g., 200). For example, such a configuration sensor may be capable of identifying whether a convertible laptop or dual tablet information handling system (e.g., 200) is placed in a closed, open clamshell, tablet, or tent configuration.

Other examples of sensors within the sensor array 230 may include light sensors, infrared (IR) cameras, or geographic position or location sensors (e.g., GPS units). In some embodiments, one or more modules of the network interface device described with reference to FIG. 1 may constitute one of the sensors within the sensor array 230. For example, an antenna front end system of the network interface device may operate to determine a location based on connection to one or more Wi-Fi networks or cellular networks. The GPS coordinates or location of the information handling system 200 and identification of one or more Wi-Fi networks or cellular networks to which the information handling system 200 connects may constitute sensor readings gathered at the sensor drivers 231 in an embodiment. All sensor readings from sensors within the sensor array 230 in an embodiment may be transmitted to the sensor drivers 231. As described in greater detail with respect to FIG. 5, these sensor readings may be transmitted from the sensor drivers 231 to the neural network of the intelligent collaboration multi-application and power management system via the processor 210 and a multimedia processing controller API 276.

It is contemplated that the information handling system 200 may include a plurality of display devices (e.g., first display 220-A and second display 220-B). One or more graphical user interfaces (GUIs) for various software applications executing concurrently with the MMCA in an embodiment may be displayed in varying layouts or configurations with respect to one another based on user preferences. For example, a user may typically prefer to display a GUI for an e-mail application on the display 220-A, and a GUI for a word processing application on display 220-B. As another example, the same user may prefer a different layout during videoconference user videoconference sessions hosted by the MMCA, such as placement of the MMCA GUI at display 220-B, and placement of both the word processing application and the e-mail application at the display 220-A. The trained neural network in an embodiment may model the relationship between the types of applications executing concurrently with the MMCA during such videoconference user videoconference sessions and the layout of such applications as they are displayed across a plurality of displays (e.g., 220-A and 220-B). With this, the trained neural network may predict a user's preferred layout of a plurality of applications during such a user videoconference session as related to relative learned user priority of applications operating concurrently with the MMCA.

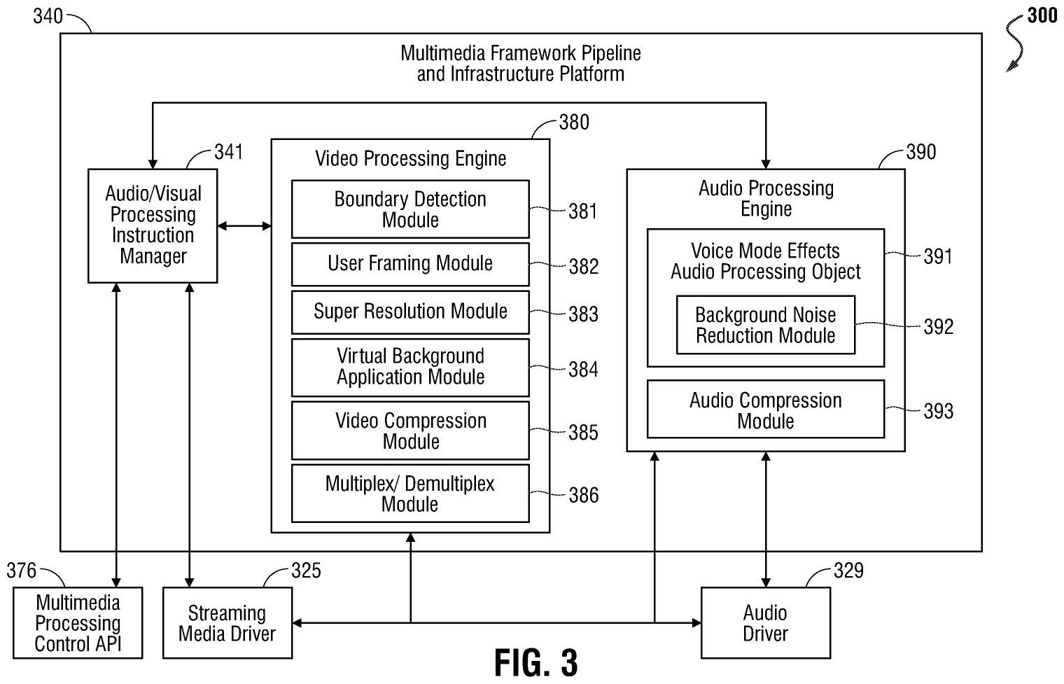

FIG. 3 is a block diagram illustrating a multimedia framework pipeline and infrastructure platform in communication with a plurality of drivers in order to process captured media samples according to an embodiment of the present disclosure. As described herein, the intelligent collaboration multi-application and power management system may optimize power and processor resource consumption by various software applications including a multimedia multi-user collaboration application (MMCA), during a videoconference session, based on availability of such power or resources and learned user priority of software applications executing concurrently with the MMCA.

The multimedia framework pipeline and infrastructure platform 340 may process media samples captured at the information handling system executing the multimedia framework pipeline and infrastructure platform 340 in one aspect of an embodiment. An example of such a multimedia framework pipeline and infrastructure platform 340 may include the Microsoft® Media Foundation Platform® for Windows®. The multimedia framework pipeline and infrastructure platform 340 in an embodiment may manage audio and video playback quality, interoperability, content protection, and digital rights management. The multimedia framework pipeline and infrastructure platform 340 may operate to retrieve audio and video samples from a media source, perform one or more processing methods on the retrieved audio and video samples, multiplex the audio and video samples together to form a processed media sample, and transmit the processed media sample to a media sink.

The multimedia framework pipeline and infrastructure platform 340 in an embodiment may include an audio/visual (A/V) processing instruction manager 341, a video processing engine 380, and an audio processing engine 390. The video processing engine 380 and audio processing engine 390 may each perform A/V processing methods or algorithms to transform media samples. Several of such methods may be performed serially to transform a single media sample in an embodiment, such as via a chaining algorithm. The A/V processing instruction manager 341 in an embodiment may schedule or otherwise manage performance of each of these methods, in turn.

In one aspect of an embodiment, a camera or microphone operably connected to the information handling system 300 may operate as the media source. In such an embodiment, the A/V processing instruction manager 341 in an embodiment may operate to retrieve a media sample from a media source, based on a media capture instruction. The A/V processing instruction manager 341 may transmit a media capture instruction to the streaming media driver 325 in an embodiment. As described in greater detail with respect to FIG. 5, the multimedia framework pipeline and infrastructure platform 340 may also be in communication with the MICA and a multimedia processing control API 376. Via such communications, the multimedia framework pipeline and infrastructure platform 340 may receive media capture instructions from the MMCA.

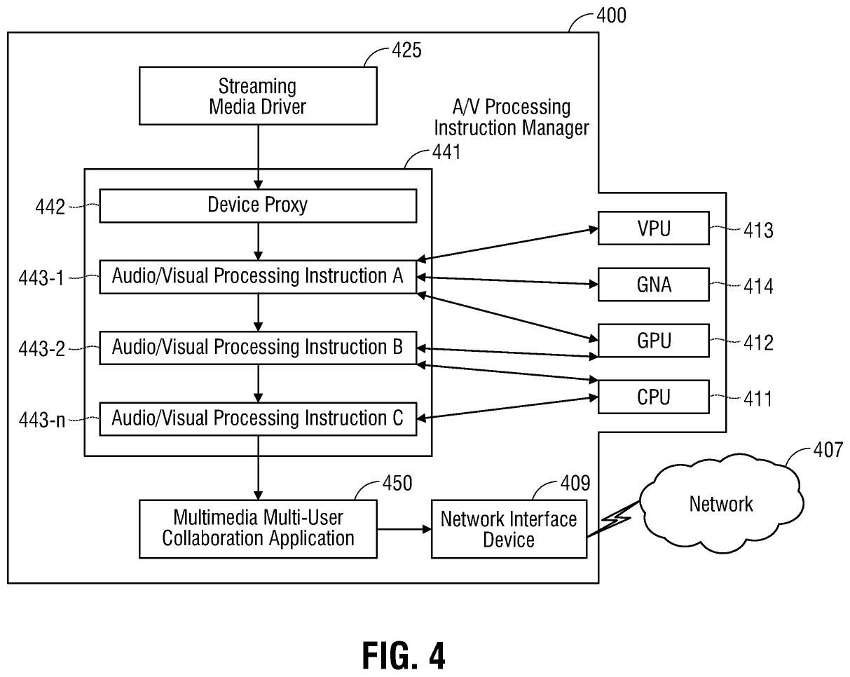

The streaming media driver 324 in such an embodiment may receive video or audio samples captured by peripheral cameras or microphones in communication therewith, according to media capture instructions, as described with reference to FIG. 2. In another embodiment, the audio driver 329 may receive audio samples captured by a microphone in communication therewith, according to such received media capture instructions. In such an embodiment, the audio driver 329 may operate as a mini-driver or child device to the parent device streaming media driver 324. The streaming media driver 325 may be in communication with the A/V processing instruction manager 341 via one or more ports (e.g., as described in greater detail with respect to the device proxy 442 of FIG. 4) such that video or audio samples received by the streaming media driver 325 may be transmitted to the A/V processing instruction manager 341 in an embodiment. The audio driver 329 may be in communication with the A/V processing instruction manager 341 such that audio samples received by the audio driver 329 may be transmitted to the A/V processing instruction manager 341 (e.g., via the audio processing engine 390, or via the streaming media driver 325) in an embodiment. In such a way, the A/V processing instruction manager 341 may direct retrieval of a video sample captured at a camera operably connected to information handling system 300 and retrieval of an audio sample captured at a microphone operably connected to information handling system 300.

The A/V processing instruction manager 341 may direct the type or the order in which various A/V processing instruction modules, are employed on media samples. The video processing engine 380 may operate to apply one or more video processing A/V processing instruction modules to a video sample, each implemented by a separate module, according to execution instructions received from the A/V processing instruction manager 341. The audio processing engine 390 may operate to apply one or more audio processing A/V processing instruction modules to an audio sample, each implemented by a separate audio processing object, according to execution instructions received from the A/V processing instruction manager 341. The one or more A/V processing instruction modules may include application of a codec to compress each of the audio sample and the video sample as required for transmission of media samples across the internet, and playback of those media samples by the MMCA, and a multiplexer to coalesce the compressed audio sample and compressed video sample into a processed, encoded (e.g., by a codec) media sample. Other processing methods in an embodiment may be dictated by one or more features of the MMCA, or optimized instructions received from the intelligent collaboration multi-application and power management system, as described herein.

For example, the boundary detection module 381 in an embodiment may operate to detect a boundary of a user within a captured video sample, through application of a boundary detection algorithm. The boundary detection module 381 in an embodiment may be capable of performing this task through execution of a variety of available boundary detection algorithms, each associated with varying processing demands, basic requirements, and resulting quality levels. For example, higher-quality boundary detection algorithms, such as image matting algorithms, may successfully define the boundaries of a user, even in low-lighting conditions, but may be associated with relatively higher processing demands (e.g., likely to consume more processing resources during its execution). Such higher-quality boundary detection algorithms may further identify a user's hand within the boundary of the user such that the virtual background does not obscure the user's hand, so as to provide a more polished and thoroughly accurate representation of the user.

As another example, lower-quality boundary detection algorithms, such as image segmentation algorithms may not be suitable for low-lighting conditions, but may be associated with relatively lower processing demands (e.g., likely to consume less processing resources during its execution), thus conserving processing resources for execution of other applications during a videoconference. Such lower quality boundary detection algorithms may fail to identify a user's hand within the boundary of the user, leading to the user's hand being obscured by application of a virtual background, or in the user's hand inconsistently being obscured. Thus, lower-quality boundary detection algorithms may optimize processor resources and power consumed, while producing a less polished video of the user, appropriate for more casual videoconferences. In contrast, higher-quality boundary detection algorithms may produce a more polished and professional video of the user, appropriate for communications with customers, clients, and superiors, at the expense of processor resource load and processor power consumption.

The virtual background application module 384 in an embodiment may apply a virtual background surrounding the detected boundary of the user within the captured image or video of the user. The virtual background application module 384 in an embodiment may be capable of performing this task through execution of a variety of available virtual backgrounds, each associated with varying streaming file sizes (e.g., depending on resolution of the background image applied). These variable qualities may affect quality of the virtual background applied, as well as processing resources and processing power required for its application. For example, higher-quality virtual backgrounds, such as higher resolution images or moving images may increase the streaming file size of the media sample once the virtual background is applied, and thus consume relatively more processing resources and power during its execution, but may present a highly polished image of the user. As another example, lower-quality virtual backgrounds, such as lower resolution images or still images may consume fewer processing resources or less power during application, but may present a less polished image of the user.

The user framing module 382 in an embodiment may operate to identify a user's face and center the user's face within each captured image making up the video sample. In an embodiment, the super resolution module 383 may recover a high-resolution image from a low-resolution image, using a known degradation function. It is contemplated other A/V processing instruction modules known in the art may also be employed, such as a hand detection algorithm, for example.

The compression module 385 in an embodiment may perform one or more algorithms or digital transforms to compress or decompress the received and processed video sample. Various compression algorithms may be employed in various embodiments. In some embodiments, the compression algorithm used may conform to one or more standards, selected or identified for use by the MMCA. For example, the MMCA may require all media samples transmitted to sinks (e.g., Universal Resource Identifiers or URIs) accessible by various agents or APIs of the MMCA executing across a plurality of information handling systems, adhere to the Motion Picture Experts Group 4 (MPEG-4) standard established by a Joint Technical Committee (JTC) of the International Organization for Standardization and International Electrotechnical Commission (IOS/IEC). This is only one example of a standard required by the MMCAs in an embodiment, and is meant to be illustrative rather than limiting. It is contemplated the video processing engine 380 in an embodiment may include various modules for encoding or decoding video samples or media samples using any known, or later developed standards.

The MPEG-4 standard may define one or more algorithms or A/V processing instruction modules (e.g., reduced-complexity integer discrete cosine transform) that may be used to compress and decompress video samples or audio samples. For example, the H.264 Advanced Video Coding (AVC), defined by part 10 of the MPEG-4 standard is the most widely used codec by video developers. Other video compression algorithms available under the MPEG-4 standard may also define 3D graphics compression (e.g., part 25), web video coding (e.g., part 29), internet video coding (e.g., part 33), and video coding for browsers (e.g., part 31). Each of these compression algorithms may be associated with different processing requirements for coding or decoding streaming media data in an embodiment. For example, the H.264 compression algorithm may require more processing resources than the video coding for browsers compression algorithm. Thus, the load placed on the processor executing such algorithms in an embodiment may be increased or decreased by choosing one of these compression algorithms over another.

Upon application of all other A/V processing instruction modules (e.g., 381, 382, 383, 384, and 385) in an embodiment, the multiplex module 386 may combine or coalesce the processed video sample and the processed audio sample into a single, processed and encoded (e.g., via the video compression module 385) media sample for transmission. The same, similar, or complimentary A/V processing instruction modules may be performed on remotely captured media samples received at the information handling system 300 for demultiplexing, decoding, and display or presentation on the information handling system 300, as described in greater detail below. The boundary detection module 381, user framing module 382, super resolution module 383, and virtual background application module 384 may comprise A/V processing instruction modules, which may comprise machine executable code instructions executing at various controllers or processors of the information handling system 300. Any one or more of the boundary detection module 381, user framing module 382, super resolution module 383, virtual background application module 384 or other A/V processing instruction modules routinely applied pursuant to instructions received from the MMCA (e.g., eye contact detection module, zoom and face normalizer module) may be applied to a captured video sample in an embodiment. Further, each of the algorithms executed by these modules (e.g., 381, 382, 383, and 384) may be implemented in any order. In some embodiments, one or more of the algorithms executed by these modules (e.g., 381, 382, 383, and 384) may be skipped. In other embodiments, the video processing engine 380 may skip the algorithms executed by each these modules (e.g., 381, 382, 383, and 384), and may only perform compression of the video sample via the video compression module 385, and multiplexing of the encoded or compressed video sample with the encoded or compressed audio sample via module 386.

The audio processing engine 390 may operate to process audio samples, and may include, for example, a voice mode effects audio processing object 391 and an audio compression module 393. The audio compression module 393 in an embodiment may apply a compression algorithm or codec to the captured audio sample to compress it. Several audio codecs may be used under part 3 of the MPEG-4 standard, including Advanced Audio Coding (AAC), Audio Lossless Coding (ALS), and Scalable Lossless Coding (SLS), among others. As with the video compression algorithms described directly above, each of these audio compression algorithms may be associated with different processing requirements for coding or decoding streaming audio samples in an embodiment. Thus, the choice of audio compression algorithm may affect load placed on the processor and power consumed while executing such algorithms in an embodiment.

The voice mode effects audio processing object 391 in an embodiment may include modules for application of other digital signal processing effects, including, for example, a background noise reduction module 392. In an embodiment, the background noise reduction module 392 may operate to isolate the user's voice from surrounding background noise and either amplify the user's voice, or reduce or remove the background noise. In other embodiments, the voice mode effects audio processing object 391 may include other modules for further digital signal processing effects, including voice modulation, graphic equalization, reverb adjustment, tremolo adjustment, acoustic echo cancellation, or automatic gain control. It is contemplated any known or later developed digital signal processing effects commonly used in MMCAs may also be executed as one or more modules within the voice mode effects audio processing object 391 in various embodiments. Any one or more of these voice mode effects audio process object modules (e.g., 392) may be applied to a captured audio signal in an embodiment. In other embodiments, the audio processing engine 390 may apply no voice mode effects audio processing object digital signal processes, and may only perform compression of the audio sample via the audio compression module 393. As described directly above, following processing and encoding or compression of the audio sample in such a way, the A/V processing instruction manager 341 may instruct the video processing engine 381 to multiplex or combine the processed and encoded video sample with the processed and encoded audio sample to generate a processed and encoded media sample. In such a way, the video processing engine 380 and audio processing engine 390, operating pursuant to execution instructions received from the A/V processing instruction manager 341, may combine an audio sample with a video sample, both captured at the information handling system 300, into a single, processed and encoded media sample, such that the processed and encoded media sample may be transmitted or streamed to other information handling systems via a network (e.g., the world wide web). In such a way, the multimedia framework pipeline and infrastructure platform 340 may operate to retrieve audio and video samples from a media source, perform one or more processing methods on the retrieved audio and video samples, multiplex the audio and video samples together to form a processed media sample, and transmit the processed media sample to a media sink.

FIG. 4 is a block diagram illustrating an A/V processing instruction manager operating to process media samples transmitted between a streaming media driver and a multimedia multi-user collaboration application (MMCA) of an information handling system according to an embodiment of the present disclosure. The A/V processing instruction manager 441 of a multimedia framework pipeline and infrastructure platform may operate to retrieve audio and video samples from a camera or microphone, perform one or more processing methods on the retrieved audio and video samples, multiplex the audio and video samples together to form a processed media sample, and transmit the processed media sample from a media source information handling system to a media sink information handling system.

Upon capture of such video samples and audio samples in an embodiment, the streaming media driver 425 (or other drivers) may transmit the captured video and audio samples to the A/V processing instruction manager 441 via a device proxy 442. The device proxy 442 in an embodiment may comprise code instructions operating at a controller. In an embodiment, the device proxy 442 may route or map connections between physical pins of the streaming media driver 425 (or other drivers) and the A/V processing instruction manager 441. The streaming media driver 425 may comprise firmware or software code instructions executable to allow communication between various media hardware (e.g., camera, microphone, speakers, display) and the operating system (OS). The A/V processing instruction manager 441 in an embodiment may comprise code instructions executable within the OS environment via one or more processors (e.g., VPU 413, GNA 414, GPU 412, or CPU 411) of the information handling system 400. As the A/V processing instruction manager 441 manages execution of either a video sample or an audio sample in such an embodiment, the A/V processing instruction manager 441 may employ the device proxy 442 to retrieve the video sample from one of the physical pins within a driver operably connected to the camera prior to execution of a video processing method. Similarly, the A/V processing instruction manager 441 may employ the device proxy 442 to retrieve the audio sample from one of the physical pins within a driver operably connected to the microphone prior to execution of an audio processing method. The communication between the streaming media driver 425 and the device proxy 442 in such an embodiment may be executed by the A/V processing instruction manager 441 executing code in kernel mode on the CPU 411 in an embodiment.

The A/V processing instruction manager 441 in an embodiment may apply one or more A/V processing instruction modules, each representing processing methods, on the audio sample and the video sample. For example, the A/V processing instruction manager 441 in an embodiment may perform an A/V processing instruction A 443-1 for detecting the boundary of a user within the captured video sample, perform A/V processing instruction B 443-2 for applying a virtual background around the detected boundary of the user within the captured video sample, and perform any additional A/V processing instruction C 443-n, such as compressing an audio sample or a video sample or multiplexing the processed and encoded audio and video samples together to form a processed and encoded media sample. In such an embodiment, the processed and encoded media sample may then be transmitted or streamed to the MMCA 450, where it will be streamed to a URI in the network 407 via the network interface device 409.

The information handling system 400 in an embodiment may include a plurality of processors, including, for example, a central processing unit (CPU) 411, a graphics processing unit (GPU) 412, a vision processing unit 413, and a gaussian neural accelerator (GNA) 414. The CPU 411 in an embodiment may execute the bulk of tasks relating to all software applications running via the operating system (OS), which may include the MMCA 450, the multimedia framework pipeline and infrastructure platform incorporating the A/V processing instruction manager 441, as well as several others. Increased processing load placed on the CPU 411 by the A/V processing instruction manager 441 during execution of a user videoconference session for the MMCA 450 may decrease the processing resources left available for all other applications also running at the OS, which may include word processing applications (e.g., Microsoft® Word®), presentation applications (e.g., Microsoft® PowerPoint®), e-mail applications, web browsers, and other applications routinely used in conjunction with the MMCA throughout a typical workday.

The GPU 412 in an embodiment may be a processor specialized for rapidly manipulating and altering memory to accelerate the creation of a video sample using a plurality of captures images stored in a frame buffer. GPU 412 may be more efficient at manipulating such stored video samples during image processing performed by one or more of the A/V processing instruction modules (e.g., 443-1, 443-2, and 443-n) in an embodiment. The VPU 413 in an embodiment may be specialized for running machine vision algorithms such as convolutional neural networks (e.g., as used by the boundary detection algorithm, super resolution module, zoom and face normalizer module, or eye contact correction modules described with reference to FIG. 3). The GNA 414 in an embodiment may comprise low-power co-processor to the CPU, or a System on a Chip (SoC) that can run under very low-power conditions to perform a specialized task, such as real-time translations of ongoing conversations, or various other audio and video processing methods represented by any one of the A/V processing instruction modules 443-1, 443-2, or 443-n. The GNA 414 may operate in an embodiment to offload continuous inference workloads from the CPU 411, GPU 412, or VPU 413, including but not limited to noise reduction or speech recognition, to save power and free CPU 411 resources.

Each of the A/V processing instruction modules (e.g., 443-1, 443-2, and 443-n) in an embodiment may be sets of algorithms or code instructions executed via the operating system (OS), using one of the processors of the information handling system 400 for modification of video data or audio data relating to streaming video conferencing applications. It is understood that any number of A/V processing instruction modules is contemplated in discussing 443-1 through 443-n. A single processor may execute each of the A/V processing instruction modules (e.g., 443-1, 443-2, and 443-n), a sub-group thereof, or may even execute a single A/V processing instruction, according to various embodiments. The A/V processing instruction manager 441 in an embodiment may determine which processor to access in order to execute each A/V processing instruction (e.g., 443-1, 443-2, and 443-n) in an embodiment, based on offload instructions received from the intelligent collaboration multi-application and power management system in some embodiments. For example, the A/V processing instruction manager 441 in an embodiment may access the VPU 413 or the GNA 414 to execute various video or audio processing algorithms supported by the features of the MMCA, as represented by A/V processing instruction A 443-1, pursuant to an optimized offload instruction to avoid executing that A/V processing instruction using the GPU 412 or CPU 411. As another example in an embodiment, the A/V processing instruction manager 441 may access the GPU 414 or CPU 411 to execute the audio or video compression algorithm represented by A/V processing instruction C 443-n. In yet another example in such an embodiment, the A/V processing instruction manager 441 may access CPU 411 to multiplex the processed and encoded audio and video samples into a processed and encoded media sample. In such a way, the A/V processing instruction manager 441 may retrieve audio and video samples captured at the information handling system and perform one or more processing methods on the captured audio and video samples in accordance with optimized processor utilization instructions received from the intelligent collaboration multi-application and power management system or the MMCA 450.

FIG. 5 is a block diagram illustrating a first embodiment of an intelligent collaboration multi-application and power management system for directing optimized processing of media samples for display during a user videoconference session of a multimedia multi-user collaboration application (MMCA) according to an embodiment of the present disclosure. As described herein, the intelligent collaboration multi-application and power management system 570 are code instructions executing on one or more processors of an information handling system. The intelligent collaboration multi-application and power management system 570 in an embodiment may optimize power and processor resource consumption by various software applications including the MMCA 550, during a videoconference session, based on availability of such power or resources and learned user priority of software applications executing concurrently with the MMCA.

In one example embodiment, the intelligent collaboration multi-application and power management system 570 may be an application operating within the OS for the information handling system 500, including execution of a trained neural network for determining optimized settings described herein. For example, the information handling system 500 may execute any or all of the intelligent collaboration multi-application and power management system 570 via a processor (e.g., processor 110 executing code instructions of the intelligent collaboration multi-application and power management system 170, described with reference to FIG. 1) or embedded controller 504. In another example embodiment, the intelligent collaboration multi-application and power management system 570 may be an application operating as part of an information handling system performance optimizer application 575 at an information handling system located remotely from the information handling system 500. In such an example embodiment, an agent 571 or portion of the intelligent collaboration multi-application and power management system 570 may be operating at the information handling system 500. The agent 571 of the intelligent collaboration multi-application and power management system 570 in such an embodiment may be in communication with the multimedia processing control API 576 via an internal bus of information handling system 500, and in communication with the information handling system performance optimizer application 575 via a network interface device, as described in greater detail with respect to FIG. 1.

The information handling system performance optimizer application 575 in an embodiment may operate remotely from the information handling system 500 in an embodiment. For example, the information handling system performance optimizer application 575 may operate on a server, blade, rack, or cloud-based network maintained and controlled by the manufacturer of several information handling systems, or managed by an employer or enterprise owner of several information handling systems, including information handling system 500. In such an embodiment, the information handling system performance optimizer application 575 may operate to monitor certain performance metrics at each of the plurality of such information handling systems (e.g., including 500), perform firmware and software updates, confirm security credentials and compliance, and manage user access across the plurality of information handling systems (e.g., as owned by an employer or enterprise corporation, and including 500).

A neural network of the intelligent collaboration multi-application and power management system 570 in an embodiment may make optimization determinations as described herein on a per information handling system basis, or across a plurality of information handling systems in a crowd-sourced approach. Such a determination may be made based upon a plurality of inputs, such as processing or system capabilities, various power metrics, performance metrics for a plurality of software applications including the MMCA, a positional configuration for the information handling system, indicators of communication with peripheral devices (e.g., stylus), current or default GUI display layouts, a list of concurrently operating applications, meeting metrics gathered by the MMCA, current or default media capture instructions, current or default A/V processing instructions, current or default processor utilization instructions, current or default application execution prioritization instructions or detected user utilization of applications during a videoconference session in the MMCA. These neural network input values may be gathered from a plurality of sensors, peripheral devices, and diagnostic applications, such as described in various example embodiments herein.

The multimedia processing control application programming interface 576 in an embodiment may operate, at least in part, as a hub, facilitating communication of each of these inputs to the intelligent collaboration multi-application and power management system 570, or agent 571 thereof. For example, processing capabilities may indicate processor types available or Random Access Memory (RAM) or other memory capabilities of an information handling system. In a further example, hardware performance metrics describing total processing load at one or more processors may be gathered via an embedded controller 504 in an embodiment, and transmitted to the multimedia processing control API 576. The embedded controller 504 may also gather information describing state of charge for a power management unit, which may include a battery and an AC adapter, as well as the rate at which the residual state of charge is being depleted, as described with reference to FIG. 1. The embedded controller 504 in an embodiment may gather such metrics through direct communication with the available processors (e.g., CPU, GPU, VPU, GNA, etc.) and with the power management unit (PMU). In some embodiments, such communication may occur in kernel mode.

In other embodiments, the information handling system performance optimizer application 575 may be in direct communication with the embedded controller 504 via out-of-band communications. In such embodiments, the hardware performance metrics (e.g., CPU load, current MMCA processor settings, battery state of charge, current positional configuration of information handling system 500, and docking status of the information handling system 500) may be determined by the embedded controller 504 in kernel mode and communicated to the information handling system performance optimizer application 575 directly during routine out-of-band communications between the information handling system performance optimizer application 575 and all managed information handling systems (e.g., including 500). Such out-of-band communications with the embedded controller 504 in an embodiment may be used to check security credentials or performance statistics for the information handling systems (e.g., 500), or to push software or firmware updates to the information handling systems, for example. During such routine maintenance, the information handling system performance optimizer application may accumulate, sort, and analyze all performance metrics received from all managed information handling systems (e.g., 500), including processing load across all available processors, default offload instructions associating specific processors with specific tasks, or state of remaining charge of the battery incorporated within the PMU, for example. Out-of-band communications initiated in such a way between the embedded controller 504 and the information handling system performance optimizer application 575 may be via a wireless network such as Wi-Fi or cellular, or via wired connection.

As described herein, the multimedia processing control API 576 may operate, at least in part, as a hub to facilitate communication between various hardware, firmware, and software applications operating at information handling system 500, and the intelligent collaboration multi-application and power management system 570. As another example of this, the multimedia processing control API 576 may receive software performance metrics generated at a diagnostic analysis application 505, describing applications available or running concurrent with the MMCA operations of a video conference session, current or default prioritization of execution of each of these applications, CPU usage or load, as well as a breakdown of the CPU usage attributable to each of a plurality of applications (e.g., including a MMCA 550) running via the operating system of the information handling system 500. The diagnostic analysis application 505 may determine data on how often software applications used concurrently with the MMCA operate, are interfaced with by a user, or an amount of resources consumed in various example embodiments. The multimedia processing control API 576 may forward these software performance metrics to the neural network of the intelligent collaboration multi-application and power management system 570 in an embodiment.

In yet another example of the multimedia processing control API 576 facilitating communication with the intelligent collaboration multi-application and power management system 570 the multimedia processing control API 576 may receive sensor readings taken from one or more sensors of the information handling system 500 (e.g., a hall effect sensor or hinge rotation sensor, light sensors, IR cameras, accelerometer, gyroscope, orientation sensor, or geographic position sensors), via the sensor drivers 531, as described in greater detail with respect to FIG. 2. In still another example of the multimedia processing control API 576 facilitating communication with the intelligent collaboration multi-application and power management system 570 the multimedia processing control API 576 may receive default A/V processing instruction module settings (including current or default virtual background selection or boundary detection algorithm). In other embodiments, the multimedia processing control API 576 may receive default A/V processing instruction module settings via direct communication with the multimedia framework pipeline and infrastructure platform 540. In still other embodiments, the intelligent collaboration multi-application and power management system 570 may receive such default A/V processing instruction module settings via direct communication with the MMCA 550.

The intelligent collaboration multi-application and power management system 570 in an embodiment may also communicate directly with the MMCA 550 or indirectly via the multimedia processing control API 576 to gather meeting metrics describing identification of all participants in a videoconference user videoconference session, and performance of the MMCA 550 during the user videoconference session in which the information handling system 500 participates. The intelligent collaboration multi-application and power management system 570 may receive one or more meeting metrics describing performance of the MMCA during execution of such a training user videoconference session in an embodiment. In some embodiments, these metrics may be gathered during routine out-of-band communications between the information handling system performance optimizer application 575 and the information handling system 500. Such meeting metrics may include, for example, a measure of the CPU resources consumed by the MMCA over time. Other example meeting metrics may include a measure of memory resources consumed. Still other example meeting metrics may compare CPU or memory usage by the MMCA 550 to total CPU or memory used by all applications, hardware, or firmware during the training user videoconference session.

Such meeting metrics may also describe the performance of media sample processing, transmission, and playback among a plurality of information handling systems (e.g., including 500) engaged in a single user videoconference session for the MMCA 550. For example, meeting metrics gathered by the intelligent collaboration multi-application and power management system 570 during a training session may describe latency, or a measurement of time elapsing between a first information handling system (e.g., 500) transmitting the processed, encoded media sample and a second information handling system receiving the processed, encoded media sample. As another example, meeting metrics may include a measurement of jitter, or a comparison between latency of playback for a media sample from one of the meeting participants, and latency of playback for another media sample from another of the meeting participants. Such jitter may cause the two separate media samples, which may have been recorded simultaneously, to playback such that they are out-of-sync with one another. Still other meeting metrics in an embodiment may measure bandwidth consumed by the MMCA 550, type of network used to transmit and receive media samples, packet loss (e.g., of video or audio samples), resolution and frames per second of video samples (both at the transmitting side and the receiving side), audio bitrate (both at the transmitting side and the receiving side), and one or more codecs or compression algorithms in use. In some embodiments, jitter, packet loss, latency, resolution, and frames per second may be measured separately for one or more of audio samples, video samples, and screen sharing samples.

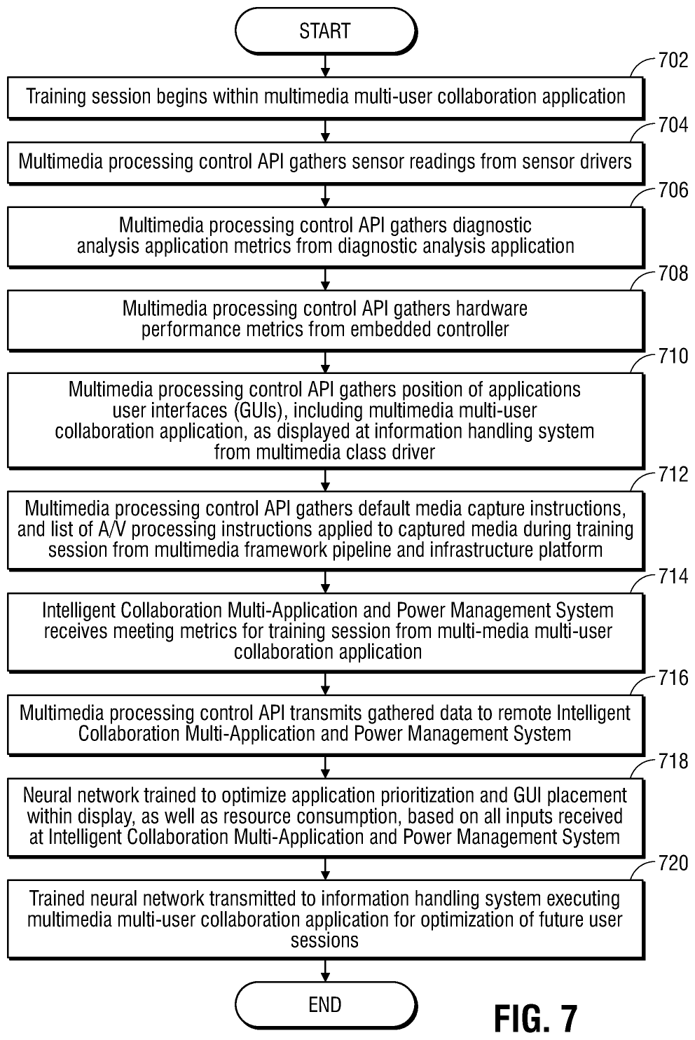

The multimedia processing control API 576 may forward received default A/V processing instruction module settings and various sensor readings to the intelligent collaboration multi-application and power management system 570 for determination of optimized adjustments to these settings using the neural network described herein. As described in greater detail with respect to FIG. 7, a neural network of the intelligent collaboration multi-application and power management system 570 may be trained based on the neural network input values gathered via the multimedia processing control API 576, as described directly above or according to embodiments described herein. Upon training of such a neural network, the neural network may be ready to determine optimized settings for the information handling system 500, based on updated input values for a videoconference using the MMCA 550. In some embodiments, this determination may be made by the neural network operating at the intelligent collaboration multi-application and power management system 570, located remotely from the information handling system 500. In other embodiments, the trained neural network for information handling system 500 may be transmitted from the intelligent collaboration multi-application and power management system 570 to an agent 571 thereof, operating at the information handling system 500.

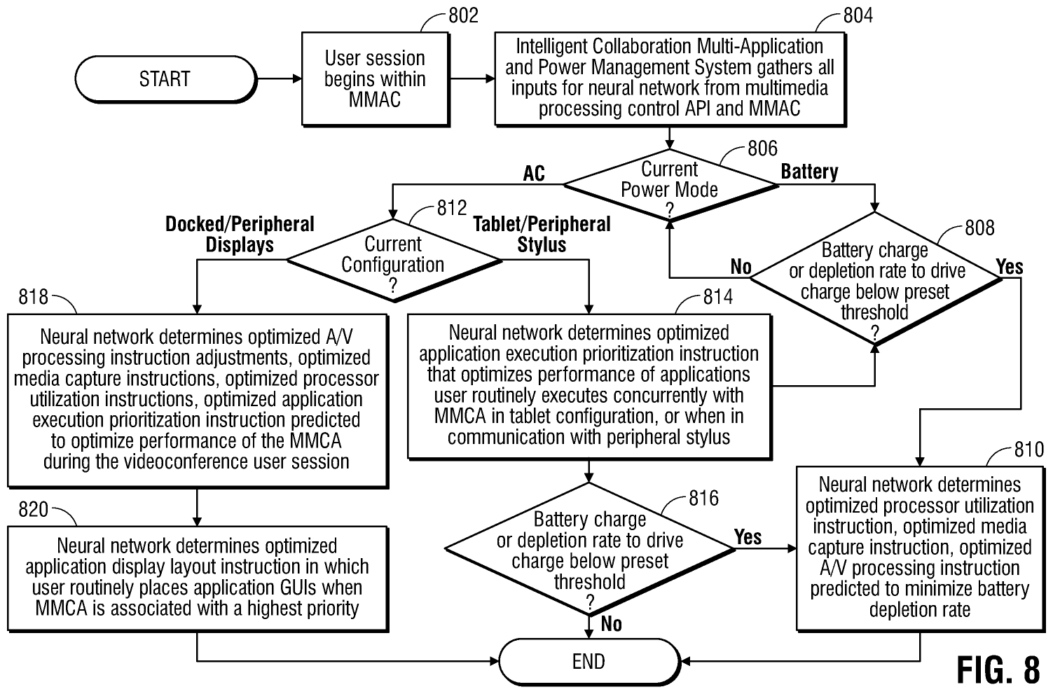

The process described directly above for gathering inputs into the neural network (e.g., via the multimedia processing control API 576), and transmission of those inputs to the intelligent collaboration multi-application and power management system 570 in an embodiment may be repeated, following training of the neural network. As described in greater detail with respect to FIG. 8, the neural network in an embodiment may determine optimized media capture instruction adjustments, optimized A/V processing instruction adjustments, optimized processor utilization instructions, or optimized application execution prioritization instructions. Each of the optimized settings or instructions output from the neural network may be transmitted to the multimedia processing control API 576 in an embodiment.

The multimedia processing control API 576 in an embodiment may transmit each of the optimized instructions received from the intelligent collaboration multi-application and power management system 570 neural network to a controller, application, or other component of information handling system 500 for implementation. For example, the multimedia processing control API 576 may transmit optimized media capture instruction adjustments to the streaming media driver 525. As described in greater detail with respect to FIG. 2, the streaming media driver 525 in an embodiment may direct the operation of the camera and the microphone such that media (e.g., images, video samples, audio samples) is captured according to the optimized media capture instruction adjustments. For example, the streaming media driver 525 in an embodiment may direct the camera to capture images and generate video samples having the frames per second, zoom settings, pan settings, or number of key frames defined by the optimized video capture instructions. As another example, the streaming media driver 525 in an embodiment may direct the microphone to capture and generate audio samples having the bitrate defined by the optimized audio capture instructions. As yet another example, the streaming media driver 525 in an embodiment may select one of a plurality of cameras to capture images and generate video samples, based on the camera selection instructions.

In other embodiments, the multimedia processing control API 576 may transmit various optimized settings or instructions to the streaming media driver 525 or to the multimedia framework pipeline and infrastructure platform 540. For example, the multimedia processing control API 576 may transmit optimized media capture instruction adjustments (e.g., including optimized video capture instructions and optimized audio capture instructions) to the streaming media driver 525 or to the multimedia framework pipeline and infrastructure platform 540. As described herein, streaming media driver 525 may direct peripherally connected cameras or microphones to capture video and audio. The streaming media driver 525 in an embodiment may do so pursuant to instructions received from the multimedia framework pipeline and infrastructure platform 540. Thus, instructions for performing such capture of media samples (e.g., video or audio samples) in an embodiment may be stored at or executed by one or more of the multimedia framework pipeline and infrastructure platform 540 or the streaming media driver 525.

As another example of the multimedia processing control API 576 transmitting optimized instructions to the multimedia framework pipeline and infrastructure platform 540, the multimedia processing control API 576 may transmit the optimized A/V processing instruction adjustment or one or more of the optimized processor utilization instructions to the multimedia framework pipeline and infrastructure platform 540. As described herein, the multimedia framework pipeline and infrastructure platform 540 may perform post-capture processing of media samples (e.g., video samples and audio samples). The multimedia framework pipeline and infrastructure platform 540 in an embodiment may include an A/V processing instruction manager 541 directing the video processing engine 580 or audio processing engine 590 to perform various post-capture media processing methods (e.g., according to the optimized virtual background selection instruction or optimized boundary detection algorithm selection instruction) via a processor identified within the optimized offload instruction on captured media samples.

In other aspects of an embodiment, the multimedia processing control API 576 may transmit optimized processor utilization instructions or optimized application execution prioritization instructions to the diagnostic analysis application 505. As described herein, the diagnostic analysis application 505 in an embodiment may operate to direct one or more processors to prioritize execution of code instructions for software applications with a learned user priority level identified as high priority in the optimized application execution prioritization instructions over execution of other concurrently executing software applications operating concurrently with the MMCA. The diagnostic analysis application 505 in an embodiment may also be in communication with the PMU to limit power drawn from one or more processors from the PMU in accordance with an optimized processor utilization instruction output by the trained neural network. Through determination and delivery of each of these optimized instructions to the information handling system 500, the intelligent collaboration multi-application and power management system 570 in an embodiment may optimize power and processor resource consumption by various software applications including the MMCA 550, during a videoconference session, based on availability of such power or resources and priority of software applications.

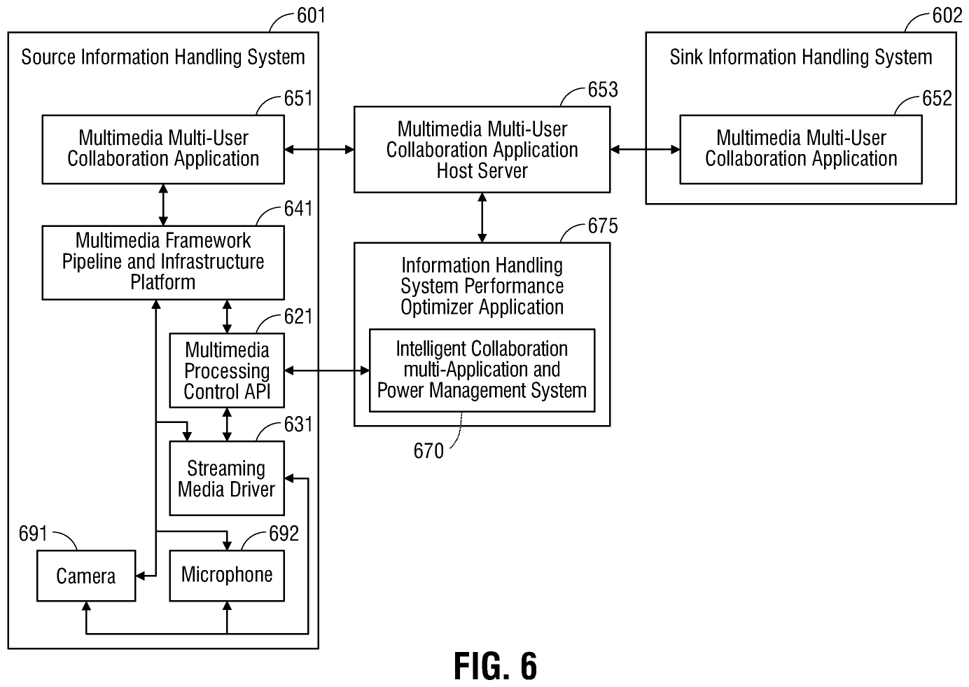

FIG. 6 is a block diagram illustrating a second embodiment of an intelligent collaboration multi-application and power management system for coordinating processing of media samples across a plurality of information handling systems that are each participating in the same user videoconference session of a multimedia multi-user collaboration application (MMCA) according to an embodiment of the present disclosure. User videoconference sessions may be hosted and coordinated by a MMCA host server 653 located remotely from, but in communication with one or more source information handling systems (e.g., 601) and one or more sink information handling systems (e.g., 602) via a network.

As described herein, the intelligent collaboration multi-application and power management system 670 may optimize power and processor resource consumption by various software applications including the MMCA (e.g., 651), during a videoconference session, based on availability of such power or resources and trained user priority of software applications operating concurrently with the MMCA. It is understood that information handling system 601 and information handling system 602, as well as any other information handling systems participating within the user videoconference session hosted by the MMCA host server 653 may operate as a media source, a media sink, or both. The intelligent collaboration multi-application and power management system 670, or separate agents thereof operating at the source information handling system 601 and sink information handling system 602, respectively, may make these determinations based on metrics specific to a single user videoconference session for the MMCA in which both the source information handling system 601 and the sink information handling system 602 are engaged. The MMCA 651 and MMCA 652 in an embodiment may operate through a shared network via a MMCA host server 653 to control engagement in videoconference systems.

The MMCA host server 653 in an embodiment may comprise a plurality of servers executing software for recording metrics for each hosted user videoconference session. Such recorded user videoconference session metrics in an embodiment may describe, for example, the identities of participants in the user videoconference session, features of the MMCA that are enabled for each participant, or the like. The additional user videoconference session metrics for a session in which the source information handling system 601 or sink information handling 602 participate may be gathered by the MMCA host server 653, and transmitted to the MMCA 651 and MICA 652 for input into the neural network of the intelligent collaboration multi-application and power management system 670 in some embodiments. For example, the source information handling system 601 may execute a neural network trained by the intelligent collaboration multi-application and power management system 670, based on inputs previously gathered at the source information handling system 601 (e.g., as described with reference to FIGS. 2 and 5) to make such a determination.

As described herein, for example in an embodiment described with reference to FIG. 5, the intelligent collaboration multi-application and power management system 670 may transmit optimized settings or instructions to the multimedia processing control API 621, based on outputs from the trained neural networks for information handling system 601. In an embodiment shown in FIG. 6, in which the intelligent collaboration multi-application and power management system 670 operates within the information handling system performance optimizer application 675, remotely from either the source information handling system 601 or the sink information handling system 602, the intelligent collaboration multi-application and power management system 670 may determine such optimized settings or instructions for the source information handling system 601 using a neural network trained specifically based on neural network input values previously received from the source information handling system 601, or from other information handling systems (e.g., 602) in a crowd-source approach. The intelligent collaboration multi-application and power management system 670 in such an embodiment may transmit the optimized settings or instructions output by this neural network to the multimedia processing control API 621, for example. In other example embodiments, the multimedia processing control API 621 may receive such optimized settings or instructions output by such a neural network operating at the source information handling system 601.

Optimized settings or instructions output by such a neural network and transmitted to the multimedia processing control API 621 of the source information handling system 601 in an embodiment may include, for example, optimized media capture instruction adjustments, optimized A/V processing instruction adjustments, optimized processor utilization instructions, optimized application execution prioritization instructions, or optimized application display layout instructions. The trained neural network of the intelligent collaboration multi-application and power management system 670 in an embodiment may output these optimized instructions or adjustments based on inputs such as processing or system capabilities, various power metrics, performance metrics for a plurality of software applications including the MMCA, a positional configuration for the information handling system, indicators of communication with peripheral devices (e.g., stylus), current or default GUI display layouts, a list of concurrently operating applications, meeting metrics gathered by the MMCA, current or default media capture instructions, current or default A/V processing instructions, current or default processor utilization instructions, or current or default application execution prioritization instructions or detected user utilization of concurrently operating software applications during videoconference sessions via the MMCA. For example, the trained neural network may output one or more of an optimized A/V processing instruction adjustment, optimized processor utilization instructions, optimized media capture instruction adjustments, or optimized application execution prioritization instructions. The intelligent collaboration multi-application and power management system 670 in an embodiment may transmit the optimized media capture instruction adjustments, optimized A/V processing instruction adjustments, or one or more optimized processor utilization instructions to the multimedia framework pipeline and infrastructure platform 641. In another aspect of an embodiment, the intelligent collaboration multi-application and power management system 670 may transmit one or more of the optimized processor utilization instructions, or optimized application execution prioritization instructions to a diagnostic analysis application via the multimedia processing control API 621.

The streaming media driver 631 in an embodiment may direct the camera 691 to capture video samples of the user of information handling system 601 and direct the microphone 692 to capture audio samples of the user of information handling system 601, pursuant to the optimized media capture instruction adjustments output from the neural network of the intelligent collaboration multi-application and power management system 670. As described in greater detail with reference to FIGS. 3-4, the A/V processing instruction manager of the multimedia framework pipeline and infrastructure platform 641 in an embodiment may execute one or more A/V processing instruction modules on video samples received from the camera 691 via the streaming media driver 631, and audio samples received from the microphone 692 via the streaming media driver 631. The algorithms or methods employed during execution of each of these A/V processing instruction modules, and the processor executing such algorithms may be chosen based on the optimized A/V processing instruction adjustments or optimized processor utilization instructions in an embodiment. For example, the optimized A/V processing instruction adjustments in an embodiment may adjust the virtual background or boundary detection algorithm to require lower computing overhead at the information handling system 601. As another example, the optimized A/V processing instruction adjustments in an embodiment may adjust the virtual background or boundary detection algorithm to optimize performance of the MMCA 651, despite the associated higher computing overhead at information handling system 601.

As described with respect to FIG. 4, the load on the CPU of the source information handling system 601, and thus, the power consumed by the CPU in an embodiment may be decreased by directing the A/V processing instruction manager of the multimedia framework pipeline and infrastructure platform 641 to engage processors (e.g., GPU, VPU, GNA) other than the CPU of the source information handling system 601 to execute various A/V processing instruction modules via the optimized processor utilization instruction output by the trained neural network. In such a way, the intelligent collaboration multi-application and power management system 670 may decrease the load on the CPU at the source information handling system 601 through a variety of methods. This may free up processing power for execution of other software applications (e.g., other than the MMCA 651) during a user videoconference session for the MMCA 651, and result in greater overall user experience.

FIG. 7 is a flow diagram illustrating a method of training a neural network to model a relationship between performance of a plurality of software applications, including the multimedia multi-user collaboration application, and power consumed during execution of such applications according to an embodiment of the present disclosure. The intelligent collaboration multi-application and power management system in an embodiment may gather input variables, such as processing or system capabilities, various power metrics, performance metrics for a plurality of software applications including the MMCA, a positional configuration for the information handling system, indicators of communication with peripheral devices (e.g., stylus), current or default GUI display layouts, a list of concurrently operating applications, meeting metrics gathered by the MMCA, current or default media capture instructions, current or default A/V processing instructions, current or default processor utilization instructions, or current or default application execution prioritization instructions. These input variables may be gathered for a plurality of training sessions in which a single information handling system participates, in order to tailor the neural network to optimize performance of one or more software applications, including the MMCA, or optimize power and processor resource consumption by such various software applications during a videoconference session, based on availability of such power or resources, current positional configuration of the information handling system, or identification of one or more software algorithms (e.g., note taking application receiving communication from a peripherally connected stylus) executing concurrently with the MMCA in an embodiment. In another embodiment, these input variables may be gathered for a plurality of training session across a plurality of information handling systems in order to leverage crowd-sourced data.

By comparing different power metrics, performance metrics for a plurality of software applications including the MMCA, a positional configuration for the information handling system, indicators of communication with peripheral devices, GUI display layouts, a list of concurrently operating applications, media capture instructions, A/V processing instructions, processor utilization instructions, or application execution prioritization instructions, the neural network or networks trained herein may learn relationships between one or more of these input values and one or more potential output instructions, including an optimized media capture instruction adjustment, an optimized A/V processing instruction adjustment, an optimized processor utilization instruction, or an optimized application execution prioritization instruction.

At block 702, a training user videoconference session may begin within the MMCA in an embodiment. For example, in an embodiment described with reference to FIG. 6, a source information handling system 601 and a sink information handling system 602 may both join a single user videoconference session for the MMCA (e.g., 651 and 652) via a central, networked MMCA host server 653, an agent of which may be operating at both the source information handling system 601 and the sink information handling system 602. It is understood that each information handling system 601 and 602 may function as a media source and as a media sink. After training user videoconference sessions have been completed in an embodiment, the intelligent collaboration multi-application and power management system may generate an optimized media capture instruction adjustment, an optimized A/V processing instruction adjustment, an optimized processor utilization instruction, or an optimized application execution prioritization instruction. A plurality of training user videoconference sessions may be completed in an embodiment prior to conclusion of the training phase for the neural network of the intelligent collaboration multi-application and power management system.

The multimedia processing control API may gather sensor readings from sensor drivers at block 704 in an embodiment. For example, in an embodiment described with reference to FIG. 2, various sensor readings may be taken by the information handling system 200 and communicated to the intelligent collaboration multi-application and power management system. More specifically, the information handling system 200 may include one or more sensors within a sensor array 230 as described in various embodiments herein. All sensor readings from sensors within the sensor array 230 in an embodiment may be transmitted to the sensor drivers 231. This sensor information in an embodiment may include a positional configuration of the information handling system 200, such as closed, laptop or clamshell configuration, or tablet mode. In another embodiment described with reference to FIG. 5, the multimedia processing control API 574 may forward various sensor readings to the intelligent collaboration multi-application and power management system 570 for determination of optimized instruction using the neural network described herein.

In another example embodiment described with reference to FIG. 2, a GPS module may determine GPS coordinates, or an antenna front end system of the network interface device may operate as one of the sensors to location based on connection to one or more Wi-Fi networks or cellular networks. The GPS coordinates or other location identification of the information handling system 200 and identification of one or more Wi-Fi networks or cellular networks to which the information handling system 200 connects may constitute sensor readings gathered at the sensor drivers 231 in an embodiment. All sensor readings from sensors within the sensor array 230 in an embodiment may be transmitted to the sensor drivers 231. These sensor readings may be transmitted from the sensor drivers 231 to the neural network of the intelligent collaboration multi-application and power management system via the processor 210 and a multimedia processing controller API 276.

The multimedia processing control API in an embodiment may gather diagnostic analysis application metrics from the diagnostic analysis application at block 706. For example, in an embodiment described with reference to FIG. 2, software performance metrics, or application execution prioritization instructions may be generated at a diagnostic analysis application 205, based at least in part on communication between the diagnostic analysis application 205 and the processor 210. Such a diagnostic analysis application 205 may operate to gather metrics describing CPU usage or load, as well as a breakdown of the CPU usage attributable to each of a plurality of applications (e.g., including a MMCA) running via the operating system of the information handling system 200. These diagnostic analysis application metrics may also include maximum power levels at which one or more processors may draw power. In some embodiments, the diagnostic analysis application 205 may provide similar metrics for other types of processors for the information handling system, including, for example, a graphics processing unit (GPU), vision processing unit (VPU), or gaussian neural accelerator (GNA).

These diagnostic analysis application metrics may also include software performance metrics from monitoring which software applications and which AV processing instruction modules (and algorithms) operate concurrently with the MMCA during training videoconference sessions. Further, the diagnostic analysis application may monitor a user's utilization frequency, access frequency, or processor consumption levels attributable to those other software applications or AV processing instruction modules operating concurrently with the MMCA. These software performance metrics may be generated at the diagnostic analysis application 205 and transmitted to the neural network of the intelligent collaboration multi-application and power management system via multimedia processing controller API 276.

At block 708, the multimedia processing control API may gather hardware performance metrics from an embedded controller in an embodiment. For example, in an embodiment described with reference to FIG. 5, hardware performance metrics describing a residual state of charge of a battery powering the information handling system, and a rate at which the residual charge is being consumed during execution of various code instructions by one or more processors may be gathered via an embedded controller 504. In another example, total processing load or total power consumed at one or more processors may be gathered via the embedded controller 504 in an embodiment, and transmitted to the multimedia processing control API 576. The embedded controller 504 in an embodiment may gather such metrics through direct communication with the processor (e.g., CPU, GPU, VPU, GNA, etc.). In other embodiments, the information handling system performance optimizer application 575 may be in direct communication with the embedded controller 504 via out-of-band communications. In such embodiments, the hardware performance metrics (e.g., CPU load, current MMCA processor setting) may be determined by the embedded controller 504 in kernel mode and communicated to the information handling system performance optimizer application 575 directly during routine out-of-band communications between the information handling system performance optimizer application 575 and all managed information handling systems (e.g., including 500). Other example hardware performance metrics may include a measure of memory resources consumed. Still other example hardware performance metrics may compare CPU or other processors or memory usage by the MMCA to total CPU or other processors or memory used by all applications, hardware, or firmware during the training user videoconference session.

The multimedia processing control API in an embodiment may gather positions of various application GUIs, including a GUI for the MMCA, as displayed at the information handling system, from the multimedia class driver at block 710. For example, in an embodiment described with reference to FIG. 2, one or more graphical user interfaces (GUIs) for various software applications executing concurrently with the MMCA in an embodiment may be displayed in varying layouts or configurations with respect to one another based on user preferences. More specifically, a user may typically prefer to display a GUI for an e-mail application on the display 220-A, and a GUI for a word processing application on display 220-B. As another example, the same user may prefer a different layout during videoconference user videoconference sessions hosted by the MMCA, such as placement of the MMCA GUI at display 220-B, and placement of both the word processing application and the e-mail application at the display 220-A.

The multimedia processing control API in an embodiment may gather currently applied media capture instructions, and a list of A/V processing instructions applied to captured media, from the multimedia framework pipeline and infrastructure platform at block 712. For example, in an embodiment described with reference to FIG. 2, default media capture instructions and default A/V processing instruction module settings may be gathered via a streaming media driver 225 and transmitted to the intelligent collaboration contextual session management system. Default media capture instructions in an embodiment may be generated by the multimedia multi-user collaboration application, or may be preset by the manufacturer of the camera, microphone, or information handling system 200. It is contemplated that any media capture instructions directing the capture by the camera of images or video or directing the capture by the microphone of audio that do not constitute optimized media capture instruction adjustments generated based on the output of the neural network described herein may constitute default media capture instructions. Such default media capture instructions and optimized media capture instruction adjustments may dictate the method by which such audio, image, and video samples are captured. For example, media capture instructions may identify the frames per second at which the camera 222 may capture images for generation of a video, the resolution at which the camera captures and stores such images, the number of key frames in each preset time period, zoom settings, pan settings, or instructions to center the captured image around an identified object. As another example, media capture instructions may identify the bit rate at which the microphone 224 records and saves captured audio samples.

The multimedia processing control API may also gather a list of A/V processing instruction modules applied to captured media during a training session from the multimedia framework pipeline and infrastructure platform in such an embodiment. For example, in an embodiment described with reference to FIG. 2, default A/V processing instruction module settings may be gathered via the streaming media driver 225 and transmitted to the intelligent collaboration contextual session management system. In another example embodiment described with reference to FIG. 5, the multimedia processing control API 576 may receive default A/V processing instruction module settings from the streaming media driver 525. In other embodiments, the multimedia processing control API 576 may receive default A/V processing instruction module settings via direct communication with the multimedia framework pipeline and infrastructure platform 540. In some embodiments, the multimedia processing control API may also gather one or more current processor utilization settings from the multimedia framework pipeline and infrastructure platform. Such current processor utilization settings in an embodiment may identify a specific processor (e.g., CPU, GPU, VPU, or GNA) for execution of one or more A/V processing instruction modules, as described in greater detail with respect to FIGS. 3 and 4.

At block 714, the intelligent collaboration multi-application and power management system in an embodiment may receive meeting metrics for the training session from the MMCA. For example, in an embodiment described with respect to FIG. 5, the intelligent collaboration multi-application and power management system 570 may be in communication with the MMCA 550 executing the training user videoconference session at the information handling system 500. In another embodiment, described with reference to FIG. 6, the intelligent collaboration multi-application and power management system 670 may receive meeting metrics from the MMCA host server 653 that hosts the training session. The intelligent collaboration multi-application and power management system 670 may receive one or more meeting metrics describing performance of the MMCA during execution of such a training user videoconference session in an embodiment. Examples of meeting metrics may include indication data of whether virtual backgrounds have been enabled and which virtual backgrounds are available to be enabled. Other meeting metrics may include number of videoconference call participants in some embodiments. Yet other meeting metrics may further include indications of sharing of documents or other resources during the videoconference call. Meeting metrics may also provide data of indications relating to other features enabled or utilized on the MMCA. Meeting metrics may also indicate performance of the information handling system or the executing software system of the MMCA during its operation in some embodiments. Such meeting metrics may include, for example, a measure of the CPU, GPU, and other processing resources consumed by the MMCA over time, during the training user videoconference session. Yet other example meeting metrics may identify participants of the user videoconference session according to self-identified labels, email addresses of invited participants, social media information about participants, or other factors.

Such meeting metrics may also describe the performance of media sample processing, transmission, and playback among a plurality of information handling systems engaged in a single user videoconference session for the MMCA. For example, meeting metrics gathered by the intelligent collaboration multi-application and power management system during a training session may describe latency, or a measurement of time elapsing between a first information handling system transmitting the processed, encoded media sample and a second information handling system receiving the processed, encoded media sample. As another example, meeting metrics may include a measurement of jitter, or a comparison between latency of playback for a media sample from one of the meeting participants, and latency of playback for another media sample from another of the meeting participants. Such jitter may cause the two separate media samples, which may have been recorded simultaneously, to playback such that they are out-of-sync with one another. Still other meeting metrics in an embodiment may measure bandwidth consumed by the MMCA, type of network used to transmit and receive media samples, packet loss (e.g., of video or audio samples), resolution and frames per second of video samples (both at the transmitting side and the receiving side), audio bitrate (both at the transmitting side and the receiving side), and one or more codecs or compression algorithms in use. In some embodiments, jitter, packet loss, latency, resolution, and frames per second may be measured separately for one or more of audio samples, video samples, and screen sharing samples. In still other examples, meeting metrics may be gathered by the MMCA host server 653, and may describe the number of users, which users are screen sharing, which users are using virtual backgrounds, which users are muted, and which participants are hosting, among other descriptions of participation among a plurality of users in a single videoconference session.

The multimedia processing control API in an embodiment may transmit the data gathered at steps 704-714 to the intelligent collaboration multi-application and power management system in an embodiment at block 716. For example, in an embodiment described with reference to FIG. 5, the multimedia processing control API 574 may forward received diagnostic analysis application metrics, hardware performance metrics, positional layout of application GUIs, default media capture instructions, default A/V processing instruction module settings, and various sensor readings to the intelligent collaboration multi-application and power management system 570 for determination of optimized settings using the neural network described herein. A neural network of the intelligent collaboration multi-application and power management system 570 may be separately trained for each information handling system (e.g., including 500) in communication with or managed by the information handling system performance optimizer application 575 in an embodiment. Such a training session may be performed based on the neural network input values gathered via the multimedia processing control API 576, as described with respect to FIG. 7 at blocks 704, 706, 708, 710, 712, and 714. Upon training of such a neural network unique to each information handling system (e.g., 500), the neural network may be ready to determine optimized settings for the information handling system for which it was trained (e.g., as described in greater detail with respect to block 716), based on updated input values.

At block 718, the intelligent collaboration multi-application and power management system may input each of the values gathered from the multimedia processing control API and the MMCA into a multi-layered, feed-forward, machine-learning neural network to train the neural network to model the relationships between application prioritization and placement within a display layout, as well as power and processor resource consumption, and application performance based on all inputs received at the intelligent collaboration multi-application and power management system. For example, the neural network may be trained to model a relationship between the residual state of charge and rate of depletion of that charge, as gathered at block 708 in the hardware performance metrics, maximum power level settings as gathered at block 706, current media capture instructions, current A/V processing instructions, and current processor utilization instructions as gathered at block 712.

The intelligent collaboration multi-application and power management system in an embodiment may model a multi-layered, feed-forward, machine-learning classifier neural network in an embodiment, for example, as a deep-learning 4 (DL4) neural network. More specifically, the neural network in an embodiment may comprise a multi-layer perceptron (MLP) classifier neural network. Several such multi-layered feed-forward, machine-learning classifier neural networks exist in the art, and any of these networks may be chosen to optimize application prioritization and placement within a display layout, as well as resource consumption, or application performance. For example, the DL4 neural network may operate in a Java programming language (e.g., DL4J), or within the Scala programming language (e.g., DL4S). Other deep-learning neural networks may be modeled using Apache® Maven®, for example. In still other embodiments, the DL4 neural network may be modeled using a plurality of classifiers, including a linear MLP classifier, a Moon MLP classifier, or a Saturn MLP classifier. Each of these types of MLP classifiers in an embodiment may define a different activation function that operates to define a relationship between separate layers of the neural network.

The neural network may include a plurality of layers, including an input layer, one or more hidden layers, and an output layer. The sensor readings, diagnostic analysis application metrics, hardware performance metrics, position of applications, default or current media capture instructions, default or current A/V processing instructions, and meeting metrics gathered at blocks 704, 706, 708, 710, 712, and 714 may form the input layer of the neural network in an embodiment.

These input layers may be forward propagated through the neural network to produce an initial output layer that includes various predicted values. For example, in an embodiment in which the neural network is trained to model the relationship between the residual state of charge and rate of depletion of that charge, maximum processor power level settings, current media capture instructions, current A/V processing instructions, and current processor utilization instructions, the output layer may include a predicted rate of residual charge depletion, predicted processor power level settings, predicted media capture instructions, predicted A/V processing instructions, and predicted processor utilization instructions. The intelligent collaboration multi-application and power management system may have received known values for one or more of these predicted values or instructions in blocks 704, 706, 708, 710, or 712. Output nodes representing predicted values for these variables within the output layer in an embodiment may be compared against such known values to generate an error function for each of the output nodes. For example, the error function for the output node representing a predicted rate of residual charge depletion rate may be equivalent to the difference between that predicted output node value and the known residual charge depletion rate gathered at block 708. As another example, the error function for the output node representing a predicted maximum processor power setting may be equivalent to the difference between that predicted output node value and the known maximum processor power setting gathered at block 706.

In yet another example, the error function for the output node representing a predicted media capture instruction (e.g., defining a resolution at which to capture video images or a bitrate at which to capture audio samples) may have a value of zero if the output node value matches the current media capture instructions gathered at block 712, and may have a value of one of these values do not match. Similarly, in still another example, the error function for the output node representing a predicted A/V processing instruction (e.g., identifying a list of A/V processing instruction modules set for execution, or identifying a specific type of algorithms for use in one or more A/V processing instruction modules) may have a value of zero if the output node value matches the current A/V processing instructions gathered at block 712, and may have a value of one of these values do not match. In yet another example, the error function for the output node representing a predicted processor utilization instruction (e.g., assigning execution of one or more A/V processing instruction modules to a specifically identified processor) may have a value of zero if the output node value matches the current processor utilization settings gathered at block 712, and may have a value of one of these values do not match.

This error function may then be back propagated through the neural network to adjust the weights of each layer of the neural network. The accuracy of the predicted values in the output nodes may be optimized in an embodiment by minimizing the error functions associated with each of the output nodes. Such forward propagation and backward propagation may be repeated serially during training of the neural network, adjusting the error function during each repetition, until the error function for all of the output nodes associated with known values falls below a preset threshold value. In other words, the weights of the layers of the neural network may be serially adjusted until the output node for the predicted maximum processor power matches the known value gathered at block 706, the predicted residual charge depletion rate matches the known value gathered at block 708, and the predicted media capture instructions, predicted A/V processing instructions, and predicted processor utilization instructions match the known values gathered at block 712. It is contemplated that the values for output nodes not associated with known values, such as the CPU resources consumed by the MMCA may vary as the weight matrices are adjusted. In such a way, the neural network may be trained to provide the most accurate output layer, including a prediction of the maximum processor power, predicted media capture instructions, predicted A/V processing instruction adjustments, and predicted processor utilization instructions that may achieve a desired residual charge depletion rate.

As another example of a relationship modeled by the neural network in an embodiment, the neural network may be trained to model a relationship between current application execution prioritization instructions, if any, gathered at block 706, detection of a peripheral stylus or orientation gathered at block 704, identification of one or more software applications executing concurrently with the MMCA, a user's access and utilization of those concurrent software applications, or other software application metrics gathered at block 706. These input values may be forward propagated through the neural network to produce an initial output layer that includes a predicted application execution prioritization instruction, or a predicted CPU usage rate for various applications running concurrently with the MMCA. The output node values for the predicted application execution prioritization instructions, or CPU usage rate for those applications within the output layer in an embodiment may be compared against the known values for these metrics as gathered at block 706 to generate an error function. For example, the error function for a CPU usage rate for one of the applications executing concurrently with the MMCA may be equivalent to the difference between this output predicted value and the known CPU usage rate for that application during the videoconference user videoconference session. As another example, the error function for a predicted application execution prioritization instruction may have a value of zero if it matches a known application execution prioritization instruction, and a value of one if it does not match. In another example embodiment, the error function for a predicted application execution prioritization instruction may have a value of zero if the instruction identifies an application associated with a highest known CPU usage rate, and a value of one if the instruction identifies an application associated with a CPU usage rate less than the CPU usage rate associated with other software applications running concurrently with the MMCA. In such an embodiment, the relatively lower CPU usage rate associated with the application may indicate there is no need to prioritize execution of that application at the CPU, because that application appears to perform adequately with relatively lower CPU usage rate while the MMCA is executing.

This error function may then be back propagated through the neural network to adjust the weights of each layer of the neural network. Such forward propagation and backward propagation may be repeated serially during training of the neural network, adjusting the error function during each repetition, until the output node for the predicted application execution prioritization instruction or predicted CPU usage for one or more applications matches the known values gathered at block 706. In such a way, the neural network may be trained to provide the most accurate output layer, including a prediction of software applications concurrently running with the MMCA during the videoconference user videoconference session the user is most likely to prioritize when the information handling system operating an MMCA videoconference session in an embodiment. The output layer may also predict the above, in some embodiments depending upon whether the information handling system is placed in tablet mode or is in communication with a peripheral stylus. The neural network may be trained to also predict a similar prioritization for AV processing instruction modules used to post-process AV media data by the MMCA similar to the above determination for other software applications during the user videoconference sessions in other embodiments.

In yet another example of a relationship modeled by the neural network in an embodiment, the neural network may be trained to model a relationship between positional configuration of the information handling system (e.g., docked) gathered at block 708, media capture instructions, A/V processing instructions, processor utilization settings gathered at block 712, and one or more meeting metrics describing performance of the MMCA (e.g., latency, jitter, dropped packets, etc.) gathered at block 714 and one or more concurrent other software applications and software performance metrics gathered at block 706. These input values may be forward propagated through the neural network to produce an initial output layer that includes predicted meeting metrics describing the performance of the MMCA. The output node values for these predicted meeting metrics within the output layer in an embodiment may be compared against the known values for these metrics as gathered at block 712 to generate an error function. For example, the error function for latency may be equivalent to the difference between this output predicted latency value and the known latency value measured during the videoconference user videoconference session. As another example, the error function for jitter may be equivalent to the difference between this output predicted jitter value and the known jitter value measured during the videoconference user videoconference session. In yet another example, the error function for dropped packets may be equivalent to the difference between this output predicted dropped packets value and the known dropped packets value measured during the videoconference user videoconference session.

This error function may then be back propagated through the neural network to adjust the weights of each layer of the neural network. Such forward propagation and backward propagation may be repeated serially during training of the neural network, adjusting the error function during each repetition, until the output node for the predicted meeting metrics matches the known values gathered at block 714. In such a way, the neural network may be trained to provide the most accurate output layer, including a prediction of the MMCA performance, as represented by measured meeting metrics, when the MMCA adheres to various media capture instructions, A/V processing instructions or adjustments thereof, or processor utilization instructions given within the input layer of the neural network during various training sessions. In another aspect, the neural network may be trained to provide the most accurate output layer, including a prediction of the performance of other software application performance operating concurrently with the MMCA as well as MMCA performance based on application prioritization, processor utilization instructions, and other inputs according to embodiments herein given within the input layer of the neural network during various training sessions

In still another example embodiment, the neural network may be trained to optimize performance for one or more software applications executing concurrently with the MMCA if the inputs to the neural network indicate the information handling system is currently being used in the tablet or other configuration, a peripheral stylus device is in communication with the information handling system, and a note-taking application or other software application is running concurrently with the MMCA. In such a scenario, the neural network may, for example, output an optimized application execution prioritization instruction identifying the note taking application or other software application as a highest priority, in order to optimize performance of the note-taking application and peripherally attached stylus or other software application. Such an optimized application execution prioritization instruction may also identify yet one or more other concurrently executing applications as having a lower priority, in order to decrease the processor resources consumed by these other applications and leave more processor resources available for execution of the note-taking application identified as high priority in the optimized application execution prioritization instruction. Additionally, the neural network may be trained to reduce processing resources consumed by the MMCA to free up processing resources in some other embodiments.

In some embodiments, the neural network in such a scenario may additionally output optimized media capture instruction adjustments, optimized A/V processing instruction adjustments, or optimized processor utilization instructions to conserve power or processing resources used by the MMCA. For example, a preset power threshold value capping power drawn by the processor may be input into the neural network during training sessions. In such an example embodiment, if reducing the priority level of one or more applications executing concurrently with the higher priority applications (e.g., note-taking, or the MMCA), the neural network may adjust performance of the MMCA to meet the power cap requirements. The neural network in an embodiment may, for example, output optimized media capture instruction adjustments to reduce the streaming media size, and consequently reduce the processing power required to perform the A/V processing instructions on the captured streaming media. In another example, the neural network may output optimized A/V processing instruction adjustments to decrease the complexity of the A/V processing instructions performed on the captured streaming media, resulting in a decrease of processing resources and power consumed. In yet another example, the neural network may output an optimized processor utilization instruction to offload one or more A/V processing instructions to an alternative processor, such as a GPU, VPU, or GNA, so as to decrease the CPU resources consumed or power drawn thereby.

In yet another example embodiment, the neural network may be trained to optimize for performance of the MMCA and to tailor the layout of various GUIs based on an optimized application execution prioritization during a videoconference user videoconference session. For example, the neural network may be trained to optimize performance of the MMCA in an embodiment if inputs into the neural network indicate the information handling system is docked or drawing AC power. In such an example embodiment, the neural network may be trained to model the relationship between media capture instructions, A/V processing instructions, or processor utilization settings used during the training session and input into the neural network, and meeting metrics describing performance of the MMCA that are also input to the neural network during these same training sessions. By modeling this relationship, the neural network may be trained to identify optimized media capture instruction adjustments, optimized A/V processing instruction adjustments, and optimized processor utilization instructions predicted to optimize performance of the MMCA during future user videoconference sessions, as indicated by one or more meeting metrics of those user videoconference sessions. The neural network in such an example embodiment may model the relationship between the types of applications executing concurrently with the MMCA during such videoconference user videoconference sessions and the layout of such applications as they are displayed across a plurality of displays (e.g., 220-A and 220-B), such that the trained neural network may predict a user's preferred layout of a plurality of applications during such a user videoconference session.

At block 720, the intelligent collaboration multi-application and power management system in an embodiment may transmit the trained neural network to the information handling system for optimizing power and processor resource consumption by various software applications including the MMCA, during a videoconference session, based on availability of such power or resources and priority of software applications during future user videoconference sessions. For example, in an embodiment described with respect to FIG. 5, upon training of the neural network, the neural network may be ready to determine optimized settings for the information handling system 500, based on updated input values. In some embodiments, this determination may be made by the neural networks operating at the intelligent collaboration multi-application and power management system 570, located remotely from the information handling system 500. In other embodiments, the trained neural networks may be transmitted from the intelligent collaboration multi-application and power management system 570 to an agent 571 thereof, operating at the information handling system 500. The method for training the neural network in an embodiment may then end.

FIG. 8 is a flow diagram illustrating a method of a trained neural network determining optimized media capture instruction adjustments, optimized A/V processing instruction adjustments, optimized processor utilization instructions, or optimized application execution instructions for optimization of power and processor resource consumption by various software applications including the MMCA, during a videoconference session, based on availability of such power or resources and priority of software applications according to an embodiment of the present disclosure. As described in greater detail with respect to FIG. 7, a neural network may be trained to determine optimized power and processor resource consumption by various software applications including the MMCA, during a videoconference session, based on availability of such power or resources and priority of software applications. Feeding input values gathered during a post-training user videoconference session into such a trained neural network in an embodiment may produce optimized media capture instruction adjustments, optimized A/V processing instruction adjustments, optimized processor utilization instructions, or optimized application execution instructions during execution of that later-joined user videoconference session at the information handling system.

At block 802, a plurality of information handling systems may join a user videoconference session within the MICA in an embodiment. For example, in an embodiment described with reference to FIG. 6, a source information handling system 601 and a sink information handling system 602 may both join a videoconference user videoconference session via the MMCA host server 653. In some embodiments, the user videoconference session begun at block 802 may be joined by any number of information handling systems greater than one.

The intelligent collaboration multi-application and power management system in an embodiment may gather all the inputs for the neural network from the multimedia processing control API and MMCA at block 804. For example, the intelligent collaboration multi-application and power management system in an embodiment may repeat the method described with reference to blocks 704, 706, 708, 710, 712 and 714 in an embodiment in order to gather sensor readings, diagnostic analysis application software performance metrics, hardware performance metrics, position of applications, default or current media capture instructions, default or current A/V processing instructions, and meeting metrics.

At block 806, the intelligent collaboration multi-application and power management system may determine whether the information handling system is currently operating on AC power or battery power in an embodiment. The neural network may optimize various settings to conserve power, or to improve performance of applications likely to consume large amounts of power. In order to determine which optimization to perform, the neural network may first gauge the available power supply. If the information handling system is currently operating on battery power, the method may proceed to block 808 for potential optimization to conserve battery resources. If the information handling system is currently operating on AC power, the power supply may be considered to be unlimited, and the method may proceed to block 812 to identify one or more applications whose performance may be optimized.

The intelligent collaboration multi-application and power management system may determine at block 808 in an embodiment in which the information is currently running on battery power whether the battery depletion rate will drive battery charge level below a preset threshold value in a predicted duration of time. The current battery charge level (e.g., residual state of charge) or battery depletion rate in an embodiment may have been gathered at block 804. The preset threshold value may, in some embodiments, include a static value such as a percentage of battery capacity. In other embodiments, this preset threshold value may be set in order to ensure the information handling system has sufficient battery power to complete a scheduled MMCA videoconference user videoconference session. For example, one of the meeting metrics gathered from the MMCA in an embodiment may indicate a projected or scheduled length of the current videoconference user videoconference session, and this may be received at block 804. In such an example embodiment, the intelligent collaboration multi-application and power management system may determine the preset threshold value for the battery charge level and calculate battery depletion rate to ensure the battery power does not fall below a minimum requirement (e.g., 5%, 10%, 20%, etc.) during the predicted length of the current videoconference user videoconference session or another preset duration of time. In other words, it may be appreciated that the intelligent collaboration multi-application and power management system may determine if current power consumption rate of a battery charge level, such as a residual state of charge exceeds a power consumption threshold value to a similar effect as the above description. If the battery depletion rate will drive the battery charge level to fall below the preset threshold, this may indicate the MMCA, executing A/V processing instructions according to current settings will fully deplete the battery before the videoconference can be completed. In such a scenario, the method may proceed to block 810 to determine optimized instructions and adjustments to such execution of the MMCA predicted to avoid depletion of the battery prior to completion of the videoconference user videoconference session. If the battery depletion rate is not predicted to drive battery charge level to fall below the preset threshold, the method may proceed to block 812 determine configuration and then to identify one or more applications whose performance may be optimized.

At block 810, the neural network in an embodiment may determine an optimized maximum processor power level setting, an optimized media capture instruction adjustment, an optimized A/V processing instruction adjustment, and an optimized processor utilization instruction to conserve battery power during execution of a videoconference user videoconference session in an embodiment. As described herein with reference to FIG. 7, the neural network may be trained to model the relationship between the residual state of charge and rate of depletion of that charge, maximum processor power level settings, current media capture instructions, current A/V processing instructions, and current processor utilization instructions. Following such training, the current residual state of charge of a battery, indicator that the information handling system is operating on battery power, current rate of depletion of the residual battery charge, current media capture instructions, current A/V processing instructions, and current processor utilization settings may be input into the trained neural network.

In some embodiments, one or more preset benchmark requirements may also be input into the neural network, in the place of a current or actual reading or measurement, in order to define a parameter for optimization. For example, in an embodiment in which the information handling system is currently operating on battery power, preset threshold value for the battery depletion rate described with reference to block 808 may be input into the neural network, in the place of a measured value of such a depletion rate. Because the neural network models the relationships between this depletion rate and several variables described in the output layer, the neural network may output one or more values that may cause the battery depletion rate to fall at or below the preset threshold value described with reference to block 808 and input into the neural network. For example, the neural network may output optimized media capture instruction adjustments (e.g., decreasing resolution or bitrates at which media samples may be captured), optimized A/V processing instruction adjustments (e.g., removing one or more A/V processing instruction modules from the execution queue, or decreasing the complexity of algorithms used during such executions), or optimized processor utilization instructions (e.g., offloading execution of one or more A/V processing instruction modules to alternative processors that may perform such executions more efficiently than others). These optimized instructions and adjustments in an embodiment may be predicted to cause the depletion rate of the residual battery charge to stay at or below the preset threshold value input into the trained neural network.

The optimized processor utilization instruction in an embodiment may cap the power one or more processors may draw from the battery (e.g., 80% of max, 60% of max) in order to decrease the rate at which the residual battery charge is being depleted. In addition to, or instead of, outputting such an optimized processor utilization instruction, the neural network in an embodiment may output optimized media capture instruction adjustments, optimized A/V processing instruction adjustments, or optimized processor utilization instructions for minimizing the power consumed during execution of the MICA in an embodiment. For example, the optimized media capture instruction adjustments may decrease the resolution or bitrate at which video samples or audio samples are captured, in order to decrease streaming media sizes. As another example, the optimized A/V processing instruction adjustments may remove one or more A/V processing instruction modules, or adjust the algorithms used by such modules to those associated with lower computing overhead, and thus, lower power consumption. As yet another example, the optimized processor utilization instructions may include an optimized offload instruction directing the multimedia framework pipeline and infrastructure platform to execute one or more A/V processing instruction modules at a specific processor capable of executing such modules using minimal power. The trained neural network may also make similar optimization adjustments for any software applications operating concurrently with the MMCA when the information handling system is operating with battery charge level below or predicted to be below a threshold level according to various embodiments described in the present disclosure. In such a way, the neural network may optimize performance of the MMCA during the videoconference user videoconference session when operating on battery to meet preset benchmark values capping the rate at which the residual battery charge may be consumed during the user videoconference session. The method may then end.

In an embodiment in which the information handling system is operating on AC power or the battery depletion rate will not drive charge level below a preset threshold, the intelligent collaboration multi-application and power management system may determine a current configuration for the information handling system or peripheral devices at block 812. The configuration of the information handling system (e.g., tablet mode or docked) may indicate the priority the user places on the MMCA and on various other concurrently executing software applications. Similarly, the type and number of peripheral devices in communication with the information handling system may also indicate the priority the user places on the MMCA and on various other concurrently executing software applications. For example, if the information handling system is currently docked and displaying one or more software application GUIs across a plurality of information handling systems, this may indicate the user places a high priority on the MMCA (e.g., is hosting or presenting), or that the user wishes to use the MMCA in conjunction with one or more other applications also displayed via the multiple peripheral displays. In another example, if the information handling system is currently operating in tablet mode in which a user routinely takes notes using a peripheral stylus that is also currently operably attached to the information handling system, this may indicate that the user places a high priority on note taking applications or other software applications running concurrently with the MMCA. If the information handling system is currently operating in tablet mode or a peripheral stylus is detected, the method may proceed to block 814 to optimize performance of other software applications that are routinely executed concurrently with the MMCA when the information handling system is in tablet mode or a peripheral stylus is detected. If the information handling system is currently docked or a plurality of peripheral displays are detected, the method may proceed to block 808 to optimize performance of the MMCA.

At block 814, in an embodiment in which the information handling system is in tablet mode or a peripheral stylus is detected, the neural network may determine an optimized application execution prioritization instruction that optimizes performance of applications the user routinely executes concurrently with the MMCA in tablet configuration or in communication with a peripheral stylus. As described herein with reference to FIG. 7, the neural network may be trained to model the relationship between a prioritization of software applications executing during the videoconference user videoconference session, including the MMCA, detection of a peripheral stylus, current positional configuration of the information handling system, and identification of one or more software applications executing concurrently with the MMCA. Following such training, the current application execution prioritization setting, an indicator of peripheral stylus connection, a current positional configuration of the information handling system, and a list of currently executing software applications may be input into the trained neural network.

The trained neural network may then identify one or more applications the user routinely executes concurrently with the MMCA when the information handling system is in tablet mode or is in communication with the peripheral stylus. For example, the trained neural network may determine the user routinely executes a note-taking application concurrently with the MMCA during videoconference user videoconference sessions when the information handling system is placed in the tablet mode, or in which the information handling system is communicably coupled to the peripheral stylus the user employs to take handwritten notes. The trained neural network may output an optimized application execution prioritization instruction in an embodiment that instructs the processor to execute highly prioritized applications (e.g., the note-taking application) the user routinely executes concurrently with the MMCA during videoconference sessions in order to optimize performance of these concurrently executing applications.

At block 816, the intelligent collaboration multi-application and power management system may again determine whether the battery depletion rate is below a preset threshold. In an embodiment in which the information handling system is currently operating on AC power, the intelligent collaboration multi-application and power management system may automatically determine the battery depletion rate will not cause battery charge level to fall to or below the preset threshold. Again, it may be appreciated that the intelligent collaboration multi-application and power management system may determine if current power consumption rate of a battery charge level, such as a residual state of charge, exceeds a power consumption threshold value to a similar effect as the above threshold determination in an embodiment. If the information handling system is currently operating on battery power, the intelligent collaboration multi-application and power management may determine whether further optimization is required in order to conserve battery power. If the battery depletion rate will cause a battery charge level to fall to or below the preset threshold, this may indicate the MMCA, executing A/V processing instructions according to current settings will fully deplete the battery before the videoconference can be completed. In such a scenario, the method may proceed back to block 810 to determine optimized instructions and adjustments to such execution of the MMCA or other concurrently operating software applications predicted to avoid depletion of the battery prior to completion of the videoconference user videoconference session. If the battery depletion rate will not cause battery charge levels to fall below the preset threshold in a predicted duration of time, the optimization of the applications executing concurrently with the MMCA at block 814 may be sufficient to optimize both power consumption and performance of various applications executing during the videoconference user videoconference session, and the method may then end.

The neural network may determine at block 818 optimized instructions or adjustments predicted to optimize performance of the MMCA during the videoconference user videoconference session in an embodiment in which the information handling system is currently docked or multiple peripheral displays are detected. As described herein with reference to FIG. 7, the neural network may be trained to model the relationship between detection of a peripheral display, positional configuration of the information handling system (e.g., docked), media capture instructions, A/V processing instructions, processor utilization settings, and one or more meeting metrics describing performance of the MMCA (e.g., latency, jitter, dropped packets, etc.). Following such training, the current media capture instructions, current A/V processing instructions, current processor utilization settings, and one or more meeting metrics describing performance of the MMCA (e.g., latency, jitter, dropped packets, etc.). may be input into the trained neural network.

In some embodiments, one or more preset benchmark requirements may also be input into the neural network, in the place of a current or actual reading or measurement, in order to define a parameter for optimization. For example, in an embodiment in which the information handling system is currently operating on AC power, docked, and in communication with one or more peripheral displays, preset threshold values for one or more of the meeting metric values, such as latency, jitter, or dropped packets may be input into the neural network, in the place of a measured value of such meeting metrics. Because the neural network models the relationships between these meeting metrics descriptive of the MMCA performance and several variables described in the output layer, the neural network may output one or more values that may cause the MMCA to perform such that the meeting metrics meet the preset threshold values input into the neural network. For example, the neural network may output an optimized media capture instruction adjustments (e.g., decreasing or increasing resolution or bitrates at which media samples may be captured), optimized A/V processing instruction adjustments (e.g., removing one or more A/V processing instruction modules from the execution queue, or decreasing or increasing the complexity of algorithms used during such executions), or optimized processor utilization instructions (e.g., offloading execution of one or more A/V processing instruction modules to alternative processors that may perform such executions more efficiently than others) to improve MMCA operation. These optimized instructions and adjustments in an embodiment may be predicted to cause measured latency, jitter, or dropped packets (or other meeting metrics) to remain at or below the preset threshold value input into the trained neural network or provide for optima MMCA operation for features selected or implemented for post-processing of audio and visual data for the videoconference session.

In another embodiment, the current or optimized application execution instruction may further assign a priority (e.g., by rank, or by grouping multiple applications into low, medium, high or other hierarchical assignments) to a plurality of other software applications executing concurrently with the MMCA. The neural network in such an embodiment may output an optimized application execution prioritization instructions directing availability of processor resources to one or more other software applications executing concurrently with the MMCA, based on a priority of these software applications determined from the optimized application execution prioritization instructions. For example, the optimized application execution prioritization instructions in an embodiment may direct other software applications associated with a lowest priority to be provided minimized CPU or other processor resources, and direct software application associated with a highest priority to be provided more processing resources along with the MMCA. According to embodiments such as described above, the neural network may optimize performance of the MMCA during the videoconference user videoconference session to meet preset benchmark values during the user videoconference session.

At block 820, the trained neural network may identify an optimized application display layout instruction in which the user routinely places applications GUIs executing concurrently with the MMCA when the MMCA is associated with a highest priority. As described with respect to FIG. 7, the neural network may be trained to model the relationship between an application execution instruction prioritizing execution of the MMCA, and application di splay layouts describing the placement of various GUIs for software application executing concurrently with the MMCA. Following such training, the current or optimized application execution instruction prioritizing execution of the MMCA may be input into the trained neural network.

The current or optimized application execution instruction in such an embodiment may further assign a priority (e.g., by rank, or by grouping multiple applications into low, medium, high or other hierarchical assignments) to a plurality of other software applications executing concurrently with the MMCA. The neural network in such an embodiment may output an optimized application display layout instruction directing placement of various GUIs for applications and previous locations of GUIs with respect to one another executing concurrently with the MMCA, based on a priority of these software applications given within the input application execution instruction. For example, the optimized application display layout instruction in an embodiment may direct software applications associated with a lowest priority to be minimized, and direct software application associated with a highest priority to be displayed on a separate monitor than the monitor upon which the MMCA is being displayed. The method may then end.

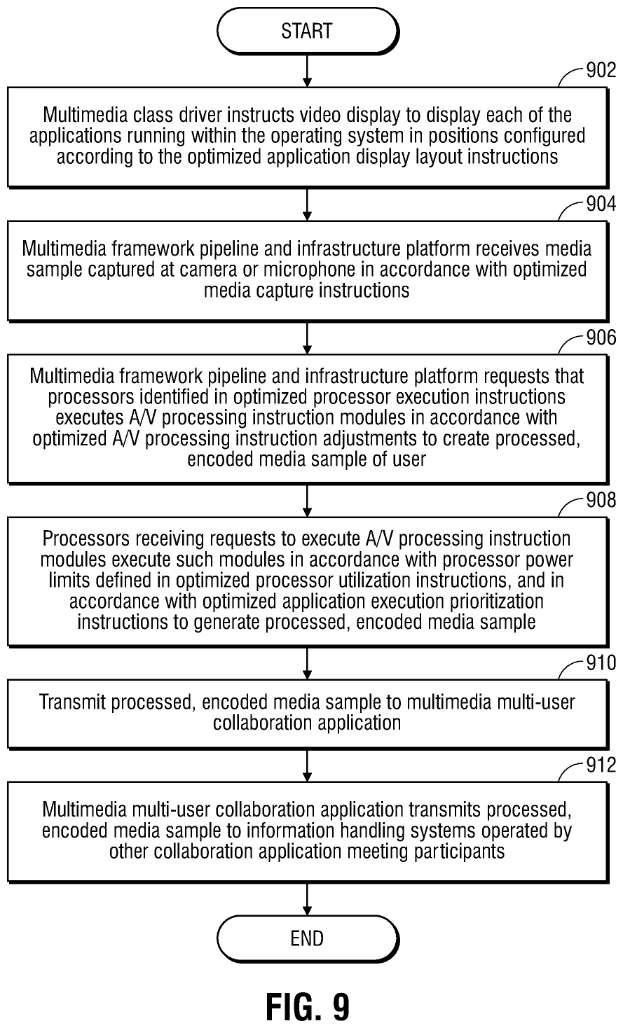

FIG. 9 is a flow diagram illustrating a method of applying optimized instructions determined by the trained neural network within a videoconference user videoconference session to optimize power management and performance of the information handling system executing the multimedia multi-user collaboration application (MMCA) or other concurrently executing software applications according to an embodiment of the present disclosure. As described herein, the neural network may be trained to optimize performance and power management of an information handling system executing an MMCA during a shared videoconference user videoconference session in an embodiment. Application of the optimized instructions generated by the trained neural network in an embodiment may adjust methods used to capture, and process media samples, as well as balance consumption of processing resources across a plurality of processors, so as to optimize power management and performance of the information handling system during user videoconference sessions for the MMCA.

At block 902, the multimedia class driver may instruct the video display to display each of the applications running within the operating system in positions configured according to the optimized application display layout instructions. For example, in an embodiment described with reference to FIG. 2, a user may typically prefer to display a GUI for an e-mail application on the display 220-A, and a GUI for a word processing application on display 220-B. As another example, the same user may prefer a different layout during videoconference user videoconference sessions hosted by the MMCA, such as placement of the MMCA GUI at display 220-B, and placement of both the word processing application and the e-mail application at the display 220-A. The optimized application display layout instructions output by the trained neural network in an embodiment may instruct the display (e.g., 220-A or 220-B) to display these GUIs in a layout reflecting the user's preferred layout of a plurality of applications during such a user videoconference session.

At block 904, the multimedia framework pipeline and infrastructure platform at one of the information handling systems participating in a joint videoconference user videoconference session in an embodiment may receive a media sample captured at a camera or microphone of the information handling system in accordance with the optimized media capture instruction adjustments. For example, in an embodiment described with reference to FIG. 6, the camera 691 of the source information handling system 601 may capture a video sample pursuant to optimized video capture instructions, and the microphone 692 may capture the audio sample pursuant to the optimized audio capture instructions. In another example embodiment described with reference to FIG. 4, the streaming media driver 425 (or other drivers) may transmit the captured video and audio samples to the A/V processing instruction manager 441 via a device proxy 442, which may route or map connections between physical pins of the streaming media driver 425 (or other drivers) and the A/V processing instruction manager 441. Decreasing the frames per second, number of key frames, or bitrate according to the optimized media capture instruction adjustments in an embodiment may cause the size of streaming media captured to decrease, which may decrease the processing power required to process such captured media samples and bandwidth needed to transmit such processed media samples. In such a way, the trained neural network in an embodiment may determine and apply optimized media capture instruction adjustments in a videoconference user videoconference session.

At block 906, the multimedia framework pipeline and infrastructure platform may request that processors identified in optimized processor execution instructions execute the A/V processing instruction modules in accordance with the optimized A/V processing instruction adjustments to create processed, encoded media samples of the user of the information handling system. The optimized processor utilization instructions output by the neural network in an embodiment may identify one or more alternate processors (e.g., GPU, VPU, or GNA) to which execution of one or more A/V processing instruction modules (e.g., boundary detection, virtual background application, etc.) may be offloaded. In such an embodiment, when the A/V processing instruction manager of the multimedia framework pipeline and infrastructure platform determines reaches an A/V processing instruction modules associated with such an alternate processor within the queue of modules for execution, the A/V processing instruction manager may transmit a request for execution of the code instructions for that module to the processor identified within the optimized processor execution utilization instructions.

The neural network in an embodiment may have also output an optimized A/V processing instruction adjustment that adjusts the list of A/V processing instruction modules given within the queue of modules set for execution, or adjusts the algorithm or code instructions one or more A/V processing instruction modules may be set to execute. In such an embodiment, the A/V processing instruction manager may only request execution of A/V processing instruction modules identified within the A/V processing instruction modules as set for execution. Additionally, the A/V processing instruction manager may request the processor (e.g., CPU or alternate processor identified within optimized processor utilization instructions) execute the specific algorithm identified within the optimized A/V processing instruction adjustment.

The processors receiving requests to execute A/V processing instruction modules in an embodiment may execute such modules in accordance with the processor power limits defined in the optimized processor utilization instructions, and in accordance with optimized application execution prioritization instructions at block 908 to generate a processed encoded media sample. The intelligent collaboration multi-application and power management system in an embodiment may transmit one or more optimized processor utilization instructions, and optimized application execution prioritization instructions to the diagnostic analysis application at block 814. For example, in an embodiment described with respect to FIG. 2, the intelligent collaboration multi-application and power management system in an embodiment may transmit to the multimedia processing control API 276 optimized application execution prioritization instructions or one or more optimized processor utilization instructions capping the amount of power to be drawn by one or more processors 210 during execution of the MMCA or other software applications. The multimedia processing control API 276 in such an example embodiment may forward the optimized application execution prioritization instructions or one or more optimized processor utilization instructions to the diagnostic analysis application 205.

The diagnostic analysis application 205 in an embodiment may adjust the battery charge depletion rate, or adjust maximum power drawn by one or more processors based on the optimized processor utilization instructions or direct the order of execution for one or more other applications concurrently executing with the MMCA pursuant to the optimized application execution prioritization instructions. For example, the diagnostic analysis application 205 in an embodiment may execute application execution prioritization instructions to direct one or more processors 210 to prioritize execution of code instructions received from these other software applications identified as high priority in application execution prioritization instructions over execution of other concurrently executing software applications. The diagnostic analysis application 205 in an embodiment may also be in communication with the PMU 203 to limit power drawn from one or more processors 210 from the PMU 203 in accordance with an optimized processor utilization instruction output by the trained neural network.

In an embodiment the A/V processing instruction manager may transmit the processed, encoded media sample to the multimedia multi-user collaboration application at block 910. For example, in an embodiment described with reference to FIG. 6, the A/V processing instruction manager of the multimedia framework pipeline and infrastructure platform (e.g., 641) at the source information handling system (e.g., 601) may perform several A/V processing instruction modules on incoming audio and video samples, including encoding and multiplexing of these samples to form a processed, encoded media sample. In such an embodiment, the processed, encoded media sample may be then be forwarded to the multimedia multi-user collaboration application 651 for transmission (e.g., via a network) to the multimedia multi-user collaboration application 652 at the sink information handling system 602.

The multimedia multi-user collaboration application in an embodiment may transmit the processed, encoded media sample to one or more remotely located information handling systems also participating in the same user videoconference session of the multimedia multi-user collaboration application at block 912. For example, in an embodiment described with reference to FIG. 4, the processed and encoded media sample may be transmitted or streamed to the multimedia multi-user collaboration application 450, where it will be streamed to a URI in the network 407 via the network interface device 409. In an embodiment in which the locally captured media sample was captured pursuant to optimized media capture instruction adjustments (e.g., as described with reference to block 902), the resulting decrease in streaming media size may decrease the bandwidth consumed at both the source information handling system transmitting the locally captured media sample, and the remotely located sink information handling systems receiving the media sample user videoconference session. The method may then end.

The blocks of the flow diagrams of FIGS. 7, 8, and 9 or steps and aspects of the operation of the embodiments herein and discussed herein need not be performed in any given or specified order. It is contemplated that additional blocks, steps, or functions may be added, some blocks, steps or functions may not be performed, blocks, steps, or functions may occur contemporaneously, and blocks, steps or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another may communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The subject matter described herein is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system executing an intelligent collaboration multi-application and power management system, comprising:
a processor to execute code instructions of a multimedia multi-user collaboration application (MMCA) to join a videoconference session;
a battery having a residual state of charge;
a controller to detect power metrics including the residual state of charge, and a current consumption rate of the residual state of charge;
the processor to determine the current consumption rate of the residual state of charge exceeds a preset power consumption threshold value;
the processor to execute code instructions of the intelligent collaboration multi-application and power management system to input to a trained neural network the power metrics, current media capture instructions, and current Audio/Visual (A/V) processing instructions gathered by the MMCA, and to output an optimized processor utilization instruction, an optimized A/V processing instruction adjustment, and an optimized media capture instruction adjustment lowering resolution at which media samples are captured, wherein the optimized A/V processing instruction adjustment, optimized processor utilization instruction and optimized media capture instruction adjustment are predicted to decrease the power consumed by one or more processors executing code instructions of the MMCA during the videoconference session to fall below the preset power consumption threshold value;
a video camera configured to capture a video sample of the videoconference session, based on the optimized media capture instruction adjustments;
a multimedia framework pipeline and infrastructure platform configured to process the video sample by executing a plurality of A/V processing instruction modules pursuant to the optimized processor utilization instruction and the optimized A/V processing instruction adjustment.

2. The information handling system of claim 1, wherein the optimized processor utilization instruction set by the processor executes code instructions for all currently executing software applications in accordance with an adjusted power consumption rate of the residual state of charge.

3. The information handling system of claim 1, wherein the optimized processor utilization instruction identifies a maximum power level adjustment capping the electrical charge drawn by the processor.

4. The information handling system of claim 1, wherein the optimized processor utilization instruction includes an optimized offload instruction to execute one of the plurality of A/V processing instruction modules with a graphical processing unit (GPU) configured to execute the one of the plurality of A/V processing instruction modules using less power than the processor.

5. The information handling system of claim 1, wherein the optimized A/V processing instruction adjustment removes one of the plurality of A/V processing instruction modules from a queue of A/V processing instruction modules set for execution by the processor to reduce computational burden on the processor.

6. The information handling system of claim 1, wherein the optimized A/V processing instruction adjustment selects an optimized virtual background selection instruction to reduce computational burden on the processor.

7. The information handling system of claim 1, wherein the optimized A/V processing instruction adjustment selects an algorithm for compression of the captured video sample to reduce computational burden on the processor.

8. The information handling system of claim 1, wherein the optimized A/V processing instruction adjustment selects an optimized boundary detection algorithm selection instruction to reduce computational burden on the processor.

9. The information handling system of claim 1, wherein the optimized processor utilization instruction includes an optimized offload instruction for the multimedia framework pipeline and infrastructure platform to execute one of the plurality of A/V processing instruction modules with a gaussian neural accelerator (GNA) configured to execute the one of the plurality of A/V processing instruction modules using less power than the processor.

10. An intelligent method of multi-application and power management comprising:
joining a videoconference session of a multimedia multi-user collaboration application (MMCA);
detecting a positional configuration indicating the information handling system executing code instructions of the MMCA is in tablet mode, via a sensor hub;
detecting a stylus indicator indicating that a stylus peripheral device is communicably linked to the information handling system to transmit handwriting user input to a note-taking software application graphical user interface (GUI);
inputting the positional configuration of the chassis, and the stylus indicator to a trained neural network of an intelligent collaboration multi-application and power management system for optimizing performance of the note-taking software application executed concurrently with the MMCA at the information handling system to meet a preset performance benchmark requirement for the note-taking software application, during the videoconference session;
outputting from the trained neural network an optimized application execution prioritization instruction prioritizing processor execution of the MMCA and the note-taking software application over processor execution of a plurality of other concurrently running software applications; and
directing the processor to execute code instructions of the MMCA, the note-taking software application, and the plurality of other concurrently running software applications according to the optimized application execution prioritization instructions, during the videoconference session.

11. The method of claim 10, wherein the preset performance benchmark requirement is a capped value of latency between capture of media samples and transmission of processed media samples, as measured by the MMCA.

12. The method of claim 10, wherein the preset performance benchmark requirement is a capped value of packets dropped during transmission of media samples during the videoconference user videoconference session, as measured by the MMCA.

13. The method of claim 10, wherein the preset performance benchmark requirement is a capped value of jitter between playback of a plurality of media samples during the videoconference user videoconference session, as measured by the MMCA.

14. The method of claim 10, wherein the preset performance benchmark requirement is a minimum quality of service indicator for an electrical signal received by the streaming media driver from the stylus peripheral device.

15. The method of claim 10 further comprising:
outputting from the trained neural network an optimized media capture instruction adjustments to throttle the processor executing code instructions of the MMCA during the videoconference session at a preset value; and
capturing a video sample of the videoconference session, via a camera, based on the optimized media capture instruction adjustments, to reduce resolution of captured media samples and the computational burden on one or more processors executing code instructions of the MMCA to make processor capacity available to the note-taking software application.

16. The method of claim 10 further comprising:
outputting from the trained neural network an optimized A/V processing instruction adjustment, select an algorithm with lower computational burden on the processor in post processing video frames, and an optimized MMCA processor utilization instruction predicted to cap the power consumed by one or more processors executing code instructions of the MMCA during the videoconference session at a preset value; and
processing the video sample, via the processor, by executing the A/V processing instruction modules pursuant to the optimized A/V processing instruction adjustment to make processor capacity available to the note-taking software application.

17. An information handling system executing an intelligent collaboration multi-application and power management system, comprising:
a processor to execute code instructions of a multimedia multi-user collaboration application (MMCA) to join a videoconference session;
a controller to detect a docking status indicator indicating the information handling system is docked;
the processor to execute code instructions of the intelligent collaboration multi-application and power management system to input to the trained neural network a current application display layout configuration, and to output a learned user-optimized application display layout instruction directing placement of one or more GUIs for applications running concurrently with the MMCA in a peripheral display;
the processor to execute code instructions of the intelligent collaboration multi-application and power management system to input to a trained neural network meeting metrics describing performance of the MMCA, and to output an optimized media capture instruction adjustment, and an optimized A/V processing instruction adjustment, or optimized processor utilization instruction predicted to adjust performance of the MMCA at the information handling system to meet a preset performance benchmark value;
a multimedia framework pipeline and infrastructure platform configured to process the video sample by executing a plurality of A/V processing instruction modules pursuant to the optimized processor utilization instruction and the optimized A/V processing instruction adjustment.

18. The information handling system of claim 17 further comprising:
a video camera configured to capture a video sample of the videoconference session, based on the optimized media capture instruction adjustments.

19. The information handling system of claim 17 further comprising:
a streaming media driver detecting a default application graphical user input (GUI) display layout, and an external display configuration;
the processor to execute code instructions of the intelligent collaboration multi-application and power management system to input to the trained neural network the default application GUI display layout and the external display configuration and to output an optimized application GUI display layout instruction determined based on previous placement of application GUIs during training sessions for the trained neural network; and
the streaming media driver directing a video display to display a GUI for the MMCA and the additional software applications, according to the optimized application GUI display layout instruction, during the videoconference user videoconference session.

20. The information handling system of claim 17 further comprising:
a streaming media driver detecting a default application graphical user input (GUI) display layout, and an external display configuration;
terminating the videoconference session of the MMCA; and
directing the video display, via the streaming media driver, to display the GUI for each of the plurality of software applications executing at the processor, according to the default application GUI display layout instruction.
